(19) United States
(12) Patent Application Publication
(10) Pub. No.: US 2015/0193804 A1
(43) Pub. Date: Jul. 9, 2015

(54) INCENTIVE MECHANISMS FOR USER INTERACTION AND CONTENT CONSUMPTION

(71) Applicant: Microsoft Corporation, Redmond, WA (US)

(72) Inventors: Zhen Liu, Tarrytown, NY (US); Chien Chih (Jacky) Hsu, Beijing (CN); Jing-Yeu Jaw, Beijing (CN); Yuan-Ching (Samuel) Shen, Beijing (CN)

(73) Assignee: Microsoft Corporation, Redmond, WA (US)

(21) Appl. No.: 14/151,573

(22) Filed: Jan. 9, 2014

(51) Int. Cl. G06Q 30/02

(52) U.S. Cl. CPC G06Q 30/0224

(57) ABSTRACT

Methods, systems and computer program products are provided for incentivizing users to consume and interact with content. An indication is received of a time span spent by a user viewing content displayed on a display screen at a user device. An indication of a proportion of an area of the display screen filled by the displayed content is also received. A value of an incentive to be awarded to the user is determined based at least upon the time span and the indicated proportion of the area of the display screen. The value of the incentive may also take into account feedback provided by the user on the displayed content, as well as a number of interactions by the user with the displayed content. The incentive is awarded to the user.

### BACKGROUND

Today's Internet content providers have two goals. First, such content providers wish to learn about the preferences of the users that consume their content. By understanding the type of content that a particular user likes and/or dislikes, a content provider can often do a better job delivering content of interest to that user, thereby increasing the chance that the user will interact with the content. For example, if the content provider has a business model that relies on revenue generated by user interaction with display advertisements (“ads”), then it is important that the content provider deliver ads that are likely to be of interest to the user.

Second, today's Internet content providers want to ensure that users spend more time consuming and interacting with their content than they do consuming and interacting with content published by their competitors.

In the past, some content providers have attempted to learn about their users' preferences by obtaining feedback from them about content at a page/screen level. For example, content providers sometime use techniques such as a like/dislike button, a feedback/survey form, or a comments submission box to obtain user feedback about a page/screen currently being displayed to the user. One problem with such conventional approaches is that user participation is usually low. Furthermore, for feedback mechanisms such as feedback/survey forms, the quality of such participation is usually poor.

Content providers may also use cookies to collect information about a user's activities while browsing Web pages and then attempt to infer the user's preferences from such collected information. However, this approach is limited because it is technically difficult to use cookies to measure a user's interest in a particular content item in a scenario in which there are multiple content items concurrently displayed on the same page/screen. Furthermore, cookies can be easily blocked.

To encourage usage, some content providers provide users with awards for conducting particular activities. However, the use of such incentives has heretofore been limited to a small number of scenarios. For example, MICROSOFT® sponsors a reward program in association with their BINGO search engine by which users can receive rewards for conducting searches that use certain keywords. Additionally, certain publishers of applications for mobile devices sponsor rewards programs by which users can be rewarded for attaining certain achievements or conducting certain transactions such as purchases while running an application.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems and computer program products are described herein that incentivize users to provide feedback about, consume, and/or interact with content displayed on a user device. In accordance with embodiments, the user is enabled to explicitly or implicitly provide feedback about content items displayed on a user device. Each instance of feedback may be classified into one of a plurality of predefined feedback types. Information related to the number of instances of each type of feedback provided by the user is transmitted from the user device to a server. Furthermore, an amount of time that the user views the displayed content items at the user device may be provided to the server, and a proportion of the display screen taken up by the displayed content items viewed by the user may be provided to the server. This information may be individually or collectively used to determine the value of an incentive to be awarded to the user. The incentives may take the form of credits that are accumulated in association with a user account, and an interface may be provided by which the user can redeem the credits to obtain one or more items of value.

For instance, a method is described herein. An indication is received of a time span spent by a user viewing content displayed on a display screen at a user device. An indication of a proportion of an area of the display screen filled by the displayed content is also received, or may be alternatively received. A value of an incentive to be awarded to the user is determined based at least upon the time span and/or the indicated proportion of the area of the display screen. The value of the incentive may also take into account feedback provided by the user on the displayed content, as well as a number of interactions by the user with the displayed content. The incentive is awarded to the user.

In some implementations, the time span may be associated with one of a plurality of predefined time span types. The plurality of predefined time span types may include: a first time span type that indicates the time span as an amount of time that a window containing the displayed content is active on the display screen; a second time span type that indicates the time span as an amount of time that a pointer controlled by the user is positioned within a boundary of the displayed content on the display screen; and/or a third time span type that indicates the time span as an amount of time that the user is detected to be looking at the displayed content on the display screen.

In an implementation, the value of the incentive to be awarded to the user may be determined by: determining a number of usage hours for a time period based on a summation of one or more products of content viewing time span type coefficients and corresponding content viewing time spans; determining a percentage of screen size for the time period based on a summation of one or more products of display screen area proportions for displayed content and corresponding content viewing time spans; and determining an award credit for the user for the time period as a sum of a first credit for the determined number of usage hours for the time period and a second credit for the determined percentage of screen size for the time period.

In an implementation, the award credit may be determined for the user for the time period as a sum of the first credit, the second credit, and an accumulated instantaneous credit determined for the user based on feedback provided by the user on the displayed content.

In another implementation, a system is disclosed. The system includes a network interface and an evaluation engine. The network interface is operable to receive an indication of a time span spent by a user viewing content displayed on a display screen at a user device. The evaluation engine is operable to determine a value of an incentive to be awarded to the user based at least upon the time span and to award the incentive to the user.

The network interface may be further operable to receive an indication of a type of feedback provided by the user with respect to the displayed content. Tthe type of feedback provided by the user may include one of a plurality of predefined feedback types, including: a first feedback type that indicates that the user does not like the content; a second feedback type that indicates that the user likes the content and wants to see additional content that is topically related thereto; and a third feedback type that indicates that the user likes the content and wants to see additional information about the content or conduct at least one transaction with respect to the content.

In an implementation, the network interface may further be operable to receive an indication of a number of incidences of the indicated type of feedback provided by the user with respect to the displayed content.

In an implementation, the time span is associated with one of a plurality of predefined time span types, including at least one of: a first time span type that indicates the time span as an amount of time that a window containing the displayed content is active on the display screen; a second time span type that indicates the time span as an amount of time that a pointer controlled by the user is positioned within a boundary of the displayed content on the display screen; or a third time span type that indicates the time span as an amount of time that the user is detected to be looking at the displayed content on the display screen.

In an implementation, the network interface may further be operable to receive an indication of a proportion of an area of the display screen filled by the displayed content.

The evaluation engine may be configured to determine the value of the incentive to be awarded to the user based at least upon the time span spent by the user viewing the content displayed on the display screen and the proportion of an area of the display screen filled by the displayed content.

For instance, to determine the value of the incentive to be awarded to the user, the evaluation engine is configured to: determine a number of usage hours for a time period based on a summation of one or more products of content viewing time span type coefficients and corresponding content viewing time spans; determine a percentage of screen size for the time period based on a summation of one or more products of display screen area proportions for displayed content and corresponding content viewing time spans; and determine an award credit for the user for the time period as a sum of a first credit for the determined number of usage hours for the time period and a second credit for the determined percentage of screen size for the time period.

In an implementation, the evaluation engine may be configured to determine the award credit for the user for the time period as a sum of the first credit, the second credit, and an accumulated instantaneous credit determined for the user based on feedback provided by the user on the displayed content.

In an implementation, the system may further include a redemption engine operable to provide an interface by which the user can redeem the award credit.

A computer-readable storage medium is described herein comprising computer-executable instructions that, when executed by a processor, perform one or more of the methods disclosed herein. For instance, a performed method may include receiving an indication of a time span spent by a user viewing content displayed on a display screen at a user device; receiving an indication of a proportion of an area of the display screen filled by the displayed content; determining a value of an incentive to be awarded to the user based at least upon the time span and the indicated proportion of the area of the display screen; and awarding the incentive to the user.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 is a block diagram of a communication system in which a server device communicates with a user device to provide new content to the user device in response to feedback from a user interacting with displayed content at the user device, according to an example embodiment.

FIG. 2 depicts a flowchart of a method for enabling a user to provide feedback directly on displayed content at a user device, according to an example embodiment.

FIG. 3 depicts a flowchart of a method by which a user can indicate various preferences with respect to displayed content, according to an example embodiment.

FIG. 4 shows an example graphical user interface element that enables a user to indicate various preferences with respect to displayed content, according to an embodiment.

FIG. 5 is a block diagram of a server that is configured to receive a user indicated preference regarding displayed content, and to select new content based thereon, according to an example embodiment.

FIG. 6 depicts a flowchart of a method by which new content may be selected and provided in response to an indication of a categorization of displayed content and a preference regarding the displayed content provided by a user, according to an example embodiment.

FIG. 7 depicts a flowchart of a method by which a server retrieves new content based on a user indicating displayed content is not preferred, according to an example embodiment.

FIG. 8 depicts a flowchart of a method by which a server retrieves new content based on a user indication that similar content to displayed content is desired, according to an example embodiment.

FIG. 9 depicts a flowchart of a method by which a server retrieves new content based on a user indication that content providing additional information for displayed content is desired, according to an example embodiment.

FIG. 10 depicts a flowchart of a method for performing machine learning on user feedback provided on displayed content, according to an example embodiment.

FIGS. 11-24 show examples of displayed content, of interactions by users with the displayed content to provide feedback, and of newly displayed content selected based on the feedback, according to embodiments.

FIG. 25 is a block diagram of an incentive system according to an example embodiment.

FIG. 26 depicts a flowchart of a method for determining a value of an incentive based upon a type of content feedback provided by a user and awarding the incentive to the user, according to an example embodiment.

FIG. 27 depicts a flowchart of a method for determining a value of an incentive to be awarded to a user based at least upon on indication of a type of feedback provided by the user with respect to content, according to an example embodiment.

FIG. 28 depicts a flowchart of a method for determining a value of an incentive based upon a type of feedback provided by a user with respect to content and a category associated with the content and awarding the incentive to the user, according to an example embodiment.

FIG. 29 depicts a flowchart of a method for determining a value of an incentive to be awarded to a user based at least upon on indication of a type of feedback provided by the user with respect to content and a category associated with the content.

FIG. 30 shows a block diagram of an agent configured to track user interaction times with displayed content, and screen areas of displayed content, according to an example embodiment.

FIG. 31 shows a block diagram of a time span determiner configured to measure time spans that a user views displayed content, according to an example embodiment.

FIG. 32 shows a flowchart of various processes for determining a time span spent by a user viewing displayed content, according to example embodiments.

FIG. 33 shows a flowchart of a process for determining and awarding an incentive to a user for an amount of time spent viewing content and/or based on an area of a display screen used by the displayed content, according to an example embodiment.

FIG. 34 shows a flowchart of a process for calculating an award credit for a user based on an amount of time the user spent viewing content on a display screen and/or based on an area of the display screen used by the displayed content, according to an example embodiment.

FIG. 35 shows a process for calculating an award credit for a user based on an amount of time the user spent viewing content on a display screen, on an area of the display screen used by the displayed content, and on feedback provided by the user on the displayed content, according to an example embodiment.

FIG. 36 is a block diagram of an exemplary user device in which embodiments may be implemented.

FIG. 37 is a block diagram of an example computing device that may be used to implement embodiments.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Methods, systems and computer program products are described herein that incentivize users to provide feedback about, consume, and/or interact with content displayed on a user device. In accordance with embodiments, the user explicitly or implicitly provides feedback about content items displayed on a user device, wherein each instance of feedback is classified into one of a plurality of predefined feedback types. For example, each piece of feedback may be classified as one of a first feedback type that indicates that the user does not like a particular content item (e.g., “No”), a second feedback type that indicates that the user likes the particular content item and wants to see additional content that is topically related thereto (e.g., “More), and a third feedback type that indicates that the user likes the content and wants to see additional information about the content or conduct at least one transaction with respect to the content (e.g., “Deep”). Other types of feedback may include the user taking a subscription to a service associated with a content item, purchasing a product or service associated with a content item, or other type of feedback. Information related to the number of instances of each type of feedback provided by the user is transmitted from the user device to a server where such information is used to determine the value of an incentive to be awarded to the user.

Still further, an amount of time that the user views the displayed content items at the user device may be tracked and provided to the server, and/or a proportion of the display screen taken up by the displayed content items may be provided to the server.

This information may be individually or collectively used by the server to determine the value of an incentive to be awarded to the user. In a particular embodiment, the server determines the incentive value based on a number of instances of each type of feedback generated by the user. In a further embodiment, the server determines the incentive value based on a number of instances of each type of feedback generated by the user and a category associated with each content item about which feedback was provided. In a further embodiment, the server determines the incentive value based on the amount of time that the user views the one or more displayed content items at the user device, and/or a proportion of the display screen taken up by the one or more displayed content items. The incentives may take the form of credits that are accumulated in association with a user account and an interface may be provided by which the user can redeem the credits to obtain one or more items of value.

By rewarding users for providing feedback about, consuming, and/or interacting with content displayed on a user device, embodiments described herein can be used by a content provider to incentivize users to spend more time consuming and interacting with the content provider's content than they do consuming and interacting with content published by their competitors.

Furthermore, by rewarding users with incentives for providing feedback about, consuming, and/or interacting with content displayed on a user device, embodiments described herein can advantageously motivate a user to perform actions that will better enable a content provider to learn about the user's preferences. This can provide multiple benefits to the content provider. For example, by obtaining a better understanding of users' preferences, the content provider can do a better job serving content that such users are likely to be interested in. This can help to build user loyalty. As another example, by better understanding users' preferences, the content publisher can do a better job connecting advertisers of goods and services to users who are likely to be interested in purchasing those goods and services.

Section II below describes an example user interface (UI) model that can be used by embodiments to enable a user to provide feedback about content, such as content displayed on a user device. Sections III and IV describe incentive systems and methods that can be used to provide rewards to users for providing feedback about such content. The incentive systems and methods described in Sections III and IV can be used in conjunction with each other, and/or with the UI model described in Section II, although they are not limited to such implementations. Section V describes an example user device and server, each of which may be used to implement embodiments described herein. Section VI provides some concluding remarks.

### II. Example UI Model

Today, users consume a great amount of content that is accessible on networks such as the Internet. Examples of such content include images, text, videos, etc. Frequently, when content is displayed on a display screen in the form of a page (e.g., on a webpage), multiple content items may be displayed together in the page, with each content item occupying a portion of the screen. Users that view such content may desire to provide feedback on the displayed content. Current techniques for obtaining feedback on content from users tend to obtain feedback at a page/screen level. For example, techniques such as a like/dislike button, a feedback/survey form, or a comments submission box may be present to obtain user feedback on a current page/screen. Cookies are also used to collect telemetry from users, and to infer the preferences of users. Pre-defined links may also be present that a user can click on to proceed to content displayed on different content pages.

However, intuitive and straightforward techniques do not tend to exist for allowing a user, as a consumer, to express their preference on a specific content item within a page/screen. Furthermore, techniques do not exist for allowing users to change specific content displayed in a portion of a screen to some other content.

For instance, feedback mechanisms provided at the page/screen level, such as the like/dislike buttons, feedback/comment forms, cookies, etc., do not provide a break-down to the content level accuracy easily. When users click on a URL (uniform resource locator) link or advance an application to a next screen, there is no knowledge regarding the preference of the user about the previously displayed content. For example, whether the user clicked to leave a page does not indicate whether the user liked or disliked the content on the page just left. Furthermore, users typically have to finish reading an entire page/screen before leaving the page/screen for a next page/screen. The user cannot change a portion of the displayed page/screen immediately, without leaving.

Embodiments are described in this section that overcome these limitations. For instance, embodiments are described in this section that enable a user to provide feedback at the content level, including providing feedback on a specific content item displayed on a page/screen with multiple content items. Furthermore, the feedback provided by the user may cause the specific content item to be replaced with different content. The different content may be selected based on whether the user feedback indicated the user did not prefer the displayed content item (“No”), indicated the user did prefer the displayed content item and wanted to be displayed similar content (“More”), or that the user did prefer the displayed content item and wanted to be displayed more detailed information regarding the displayed content item (“Deep”). The different content may be displayed in place of the displayed content item, or may be otherwise displayed.

Accordingly, in this section, a new UI (user interface) model is presented that allows users to obtain preferred content through interactions with content providers. For instance, a user may be enabled to quickly obtain desired content by indicating their request through selecting content in the form of text (e.g., keywords, sentences, or paragraphs), images, and/or another form of content from a content provider. With regard to the content, the user may be able to indicate one or more of: “No”—replace this type of content with new (and a possibly different type of) content; “More”—the user likes this type of content and would like to get more relevant content regarding the same (e.g., different photos or news clips of the same topic); and “Deep”—the user likes this content and wants deeper or more detailed information on the content, and/or wants to incur more actions on the current content item. For example, if the content item is an advertisement, the selection by the user of “Deep” may indicate purchase behavior (e.g., the user may be interested in purchasing something related to the content item). In another example, if the content item is a news clip, the selection by the user of “Deep” might trigger a feedback input, or the display of full coverage of the news of the news clip.

Example embodiments are described in the following subsections, including embodiments for enabling users to provide feedback directly on displayed content, for selecting and displaying next content based on the feedback, and for exemplary feedback mechanisms.

A. Example Content Consumption System Embodiments

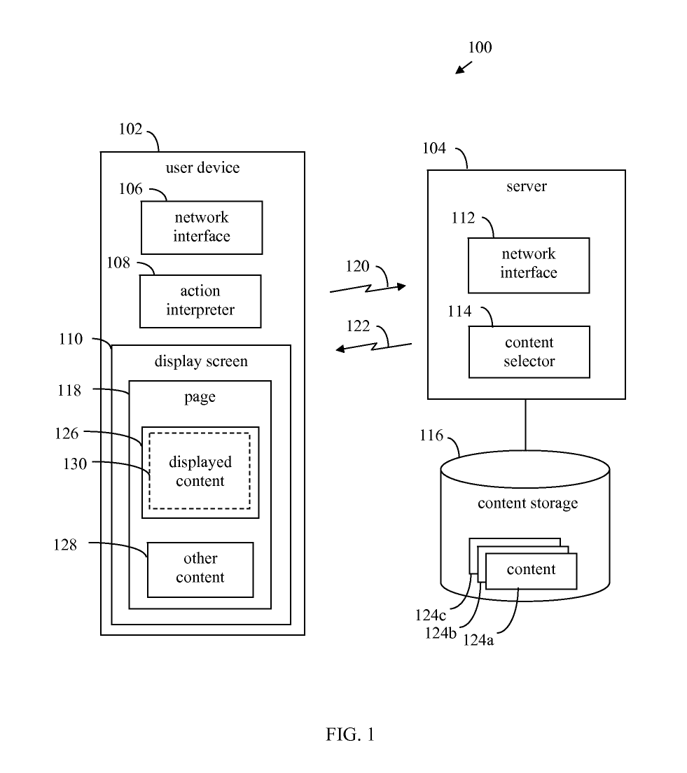

Embodiments may be implemented in devices and servers in various ways. For instance, FIG. 1 is a block diagram of a communication system 100 in which a server 104 communicates with a user device 102 to provide selected content for display at user device 102 in response to user feedback on content displayed at user device 102, according to an example embodiment. As shown in FIG. 1, user device 102 includes a network interface 106, an action interpreter 108, and a display screen 110. Server 104 includes a network interface 112 and a content selector 114. Server 104 includes or is coupled to a content storage 116.

User device 102 may be any type of stationary or mobile computing device, including a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone (e.g., a cell phone, a smart phone such as a Microsoft Windows® phone, an Apple iPhone, a phone implementing the Google® Android™ operating system, a Palm® device, a RIM Blackberry® device, etc.), a wearable computing device (e.g., a smart watch, smart glasses such as Google® Glass™, etc.), or other type of mobile device (e.g., an automobile), or a stationary computing device such as a desktop computer or PC (personal computer). Server 104 may be implemented in one or more computer systems (e.g., servers), and may be mobile (e.g., handheld) or stationary. Server 104 may be considered a “cloud-based” server, may be included in a private or other network, or may be considered network accessible in another way.

As shown in FIG. 1, content storage 116 includes content, such as first content 124a, second content 124b and third content 124c. Each item of stored content may be any type of content, such as textual content (a word, a phrase, a sentence, a paragraph, a document, etc.) or image content (e.g., an image or photo, a video, etc.). Each item of stored content may contain any form of content, such as an advertisement, a news item, etc. Content storage 116 may include one or more of any type of storage mechanism to store content in the form of files or other form, including a magnetic disc (e.g., in a hard disk drive), an optical disc (e.g., in an optical disk drive), a magnetic tape (e.g., in a tape drive), a memory device such as a RAM device, a ROM device, etc., and/or any other suitable type of storage medium.

Network interface 112 of server 104 enables server 104 to communicate over one or more networks, and network interface 106 of user device 102 enables user device 102 to communicate over one or more networks. Examples of such networks include a local area network (LAN), a wide area network (WAN), a personal area network (PAN), or a combination of communication networks, such as the Internet. Network interfaces 106 and 112 may each include one or more of any type of network interface (e.g., network interface card (NIC)), wired or wireless, such as an as IEEE 802.11 wireless LAN (WLAN) wireless interface, a Worldwide Interoperability for Microwave Access (Wi-MAX) interface, an Ethernet interface, a Universal Serial Bus (USB) interface, a cellular network interface, a Bluetooth™ interface, a near field communication (NFC) interface, etc.

Display screen 110 of user device 102 may be any type of display screen, such as an LCD (liquid crystal display) screen, an LED (light emitting diode) screen such as an organic LED screen, a plasma display screen, or other type of display screen. Display screen 110 may be integrated in a single housing of user device 102, or may be a standalone display. As shown in FIG. 1, display screen 110 may be used to display content at user device 102. For instance, a user of user device 102 may interact with a user interface of user device 102 to browse content, and cause content to be displayed by display screen 110. For instance, content may be displayed by display screen 110 that is contained in a page 118, such as a web page rendered by a web browser, or content may be displayed in another form by another application.

As shown in FIG. 1, display screen 110 may display displayed content 126 and other content 128. Displayed content 126 and other content 128 may each include one or more content items in the form of textual content or image content. In the example of FIG. 1, displayed content 126 is configured to be able to be interacted with by a user of user device 102 to provide feedback on displayed content 126, according to an embodiment. For example, as shown in FIG. 1, displayed content 126 may include a feedback interface 130 that enables a user to provide feedback on displayed content 126, such as by mouse clicks (e.g., on a displayed pop up menu, one or more virtual buttons, etc.), by touching display screen 110, by motion sensing, by speech recognition, and/or by other user interface interaction. Other content 128 may optionally be present, and may also be configured to be interacted with by a user to provide feedback thereon, or may not be configured to provide feedback.

Action interpreter 108 is configured to interpret the feedback of the user provided with respect to displayed content 126 using feedback interface 130. For example, as described elsewhere herein, the user may provide feedback with respect to displayed content 126 in the form of not preferring displayed content 126 (e.g., not wanting to view displayed content 126, but wanting to display alternative content instead), referred to herein as a feedback selection of “No”; preferring displayed content 126 and wanting to view additional similar content, referred to herein as a feedback selection of “More”; and preferring displayed content 126 and wanting to view additional content that is more descriptive of displayed content 126 and/or conduct a transaction with respect to displayed content 126, referred to herein as a feedback selection of “Deep”. Action interpreter 108 is configured to receive the feedback provided to feedback interface 130 by the user, and provide the feedback to network interface 106 to be transmitted to server 104.

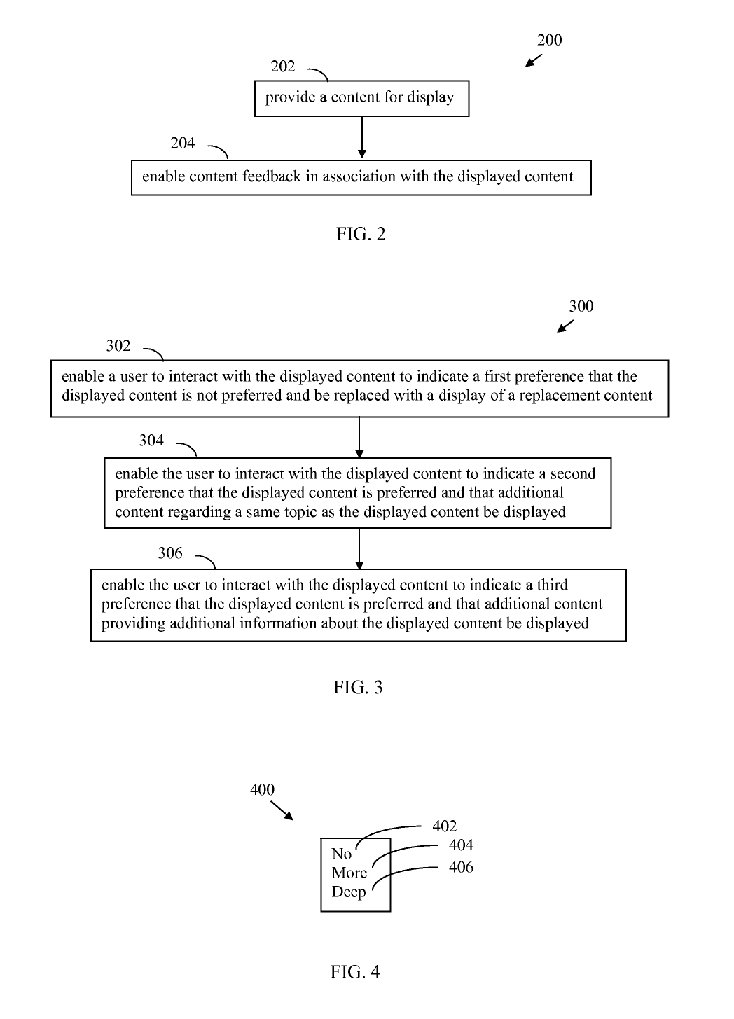

As such, in an embodiment, user device 102 may operate according to FIG. 2. FIG. 2 depicts a flowchart 200 of a method for enabling a user to provide feedback directly on displayed content at a user device, according to an example embodiment. Flowchart 200 is described as follows. Further structural and operational embodiments will be apparent to persons skilled in the relevant art(s) based on the following description.

Flowchart 200 begins with step 202. In step 202, content is provided for display. For instance, as shown in FIG. 1, display screen 110 of user device 102 may display displayed content 126, and optionally may display further content such as other content 128. Such content may be displayed in page 118 or in another form.

In step 204, content feedback is enabled in association with the displayed content. For instance, as described above, user device 102 may provide feedback interface 130 in association with displayed content 126 to enable a user of user device 102 to provide feedback on displayed content 126. Such feedback may be received by action interpreter 108.

FIG. 3 depicts a flowchart 300 of a method by which a user can indicate various preferences with respect to displayed content, according to an example embodiment. For instance, flowchart 300 may be performed as an example of step 204 of flowchart 200 in FIG. 2. Flowchart 300 is described as follows. Further structural and operational embodiments will be apparent to persons skilled in the relevant art(s) based on the following description.

Flowchart 300 begins with step 302. In step 302, a user is enabled to interact with the displayed content to indicate a first preference that the displayed content is not preferred and be replaced with a display of a replacement content. For example, as described above with respect to FIG. 1, the user of user device 102 may be enabled to interact with feedback interface 130 to indicate the “No” preference with respect to displayed content 126.

In step 304, the user is enabled to interact with the displayed content to indicate a second preference that the displayed content is preferred and that additional content regarding a same topic as the displayed content be displayed. For example, as described above, the user of user device 102 may be enabled to interact with feedback interface 130 to indicate the “More” preference with respect to displayed content 126.

In step 306, the user is enabled to interact with the displayed content to indicate a third preference that the displayed content is preferred and that additional content providing additional information about the displayed content be displayed. For example, as described above, the user of user device 102 may be enabled to interact with feedback interface 130 to indicate the “Deep” preference with respect to displayed content 126.

As described above, feedback interface 130 may be configured to enable the user to provide their feedback in any suitable form, including by one or more of mouse clicks, touch, motion, voice, etc. For instance, FIG. 4 shows an example graphical user interface (GUI) element 400 that enables a user to indicate various preferences with respect to displayed content, according to an embodiment. As shown in FIG. 4, GUI element 400 may be a list or a pop up menu that is present when a user interacts with displayed content 126 of FIG. 1. For instance, when the user hovers a mouse pointer over displayed content 126, touches displayed content 126 on display screen 110, makes a particular predetermined hand motion, speaks a predetermined one or more words, or interacts with displayed content 126 via feedback interface 130 in another way, GUI element 400 may be displayed adjacent to or over displayed content 126 in display screen 110. The user may then provide a subsequent action, such as a click, a touch, a motion, or a speaking of the appropriate word, to indicate their feedback of one of “No”, “More”, or “Deep” (or other suitable labels provided in GUI element 400). Note that GUI element 400 is shown for purposes of illustration, and in other embodiments may have other suitable forms, as would be apparent to persons skilled in the relevant art(s) based on the teachings herein (e.g., a radio button, a pull down menu, etc.).

As shown in FIG. 1, network interface 106 of user device 102 may transmit a content feedback signal 120 to server 104 that indicates the feedback provided by the user to displayed content 126 and received by action interpreter 108. Content feedback signal 120 may also include identifying information for displayed content 126. As shown in FIG. 1, network interface 112 of server 104 may receive content feedback signal 120. Content selector 114 at server 104 is configured to select next content to be displayed for displayed content 126 based on the feedback received in content feedback signal 120.

For instance, if content feedback signal 120 indicates that the user did not prefer displayed content 126 (e.g., “No”), content selector 114 may select content that is not related to displayed content 126 (e.g., a different category and/or topic of content). If content feedback signal 120 indicates that the user did prefer displayed content 126, and thus desires additional similar content (e.g., “More”), content selector 114 may select content that is related to displayed content 126 (e.g., categorized in a same category, and optionally in a same topic). If content feedback signal 120 indicates that the user did prefer displayed content 126, and thus desires content that is more descriptive of displayed content 126 (e.g., “Deep”), content selector 114 may select content that is closely related to displayed content 126 (e.g., categorized in a same category, and a same topic of content under the same category).

Content selector 114 may retrieve the selected next content from content storage 116 (e.g., one or more of first content 124a, second content 124b, third content 124c and/or other content stored in content storage 116), and provide the selected next content to network interface 112 to transmit to user device 102. As shown in FIG. 1, network interface 112 transmits a selected next content signal 122 from server 104 that includes the next content selected by content selector 114 in response to content feedback signal 120. Network interface 106 of user device 102 may receive selected next content signal 122. The selected next content received in selected next content signal 122 may be displayed in page 118 by display screen 110 for the user to view. In an embodiment, the selected next content may be displayed in page 118 in place of displayed content 126, in a same size and position in page 118 as displayed content 126 was displayed.

In this manner, a user of user device 102 is enabled to provide content-specific feedback on content that may be displayed in a screen/page side-by-side with other content. Furthermore, the feedback is more than a mere like/dislike type of content, but also indicates further types of content that the user may desire to be displayed (e.g., different content, similar content, content that is more descriptive, etc.). Still further, the content that is selected in response to the feedback may be displayed in place of the displayed content that the feedback was provided on. Thus, a portion of a displayed page/screen may be changed based on user feedback, while the rest of the page/screen does not change.

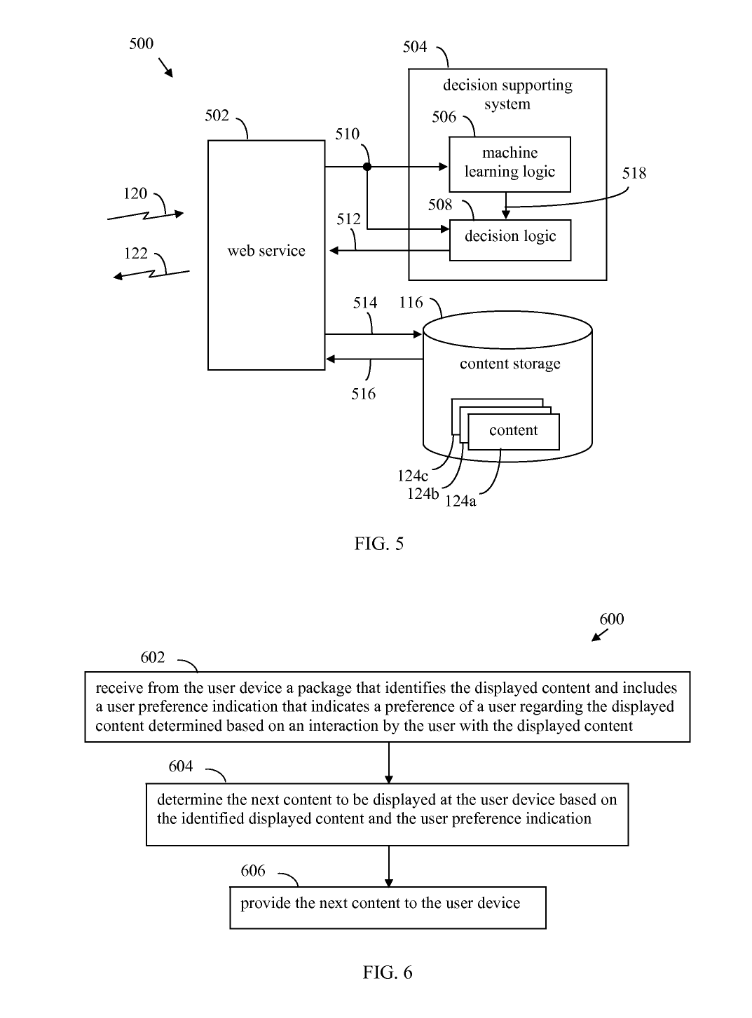

In embodiments, server 104 may be configured in various ways to perform its functions. FIG. 5 is a block diagram of a server 500 that is configured to receive a user-indicated preference regarding displayed content, and to select new content based thereon, according to an example embodiment. Server 500 is an example of server 104 shown in FIG. 1. As shown in FIG. 5, server 500 includes a web service 502, a decision supporting system 504, and content storage 116. Furthermore, decision supporting system 504 includes machine learning logic 506 and decision logic 508.

For ease of illustration, server 500 is described with reference to FIG. 6. FIG. 6 depicts a flowchart 600 of a method by which new content is selected and provided in response to a categorization of and feedback provided regarding displayed content, according to an example embodiment. In an embodiment, server 500 may operate according to flowchart 600. Flowchart 600 and server 500 are described as follows. Further structural and operational embodiments will be apparent to persons skilled in the relevant art(s) based on the following description.

Flowchart 600 begins with step 602. In step 602, a package is received from the user device that identifies the displayed content and includes a user preference indication that indicates a preference of a user regarding the displayed content determined based on an interaction by the user with the displayed content. For example, as shown in FIG. 5, web service 502 receives content feedback signal 120 from user device 102. Content feedback signal 120 may include a user data package that identifies displayed content 126, and indicates the feedback provided by the user to displayed content 126.

Displayed content 126 may be identified in the package in various ways, such as by one or more identifiers (e.g., numerical, alphanumerical, etc.) and/or other identifying information. For instance, in an embodiment, each content item may be classified in a topic of a category, where multiple categories may be present, and each category includes multiple topics. Thus, each content item, such as displayed content 126, first content 124a, second content 124b, third content 124c, etc., may be categorized by a category and topic. For example, in an embodiment, each content item may have an associated category identifier that indicates a category of the content item, may have an associated topic identifier that indicates a topic of the content item, and may have an associated content identifier that specifically (e.g., uniquely) identifies the content item itself.

Accordingly, content feedback signal 120 may include an indication of a first category identifier that indicates a category of displayed content 126, a first topic identifier that indicates a topic of displayed content 126, a first item identifier that identifies displayed content 126, and a user preference indication provided as the feedback provided by the user to displayed content 126.

Categories, topics, and content may be organized in a hierarchy in any manner, with categories at the top (broadest) and content at the bottom (most specific). Any number of different types of categories and topics may be present. Examples of categories may include news, consumer products, automobiles, technology, etc. Examples of topics under the news category may include entertainment, politics, sports, etc. Examples of topics under the consumer products category may include luxury, clothing, etc. Examples of topics under the automobiles category may include Ford, Lexus, Honda, sports cars, etc. Thus, a topic is categorized in the hierarchy as a subset of a category. Examples of content under the Ford topic may include the Focus automobile, the Fusion automobile, the Escape automobile (and/or further models of automobiles manufactured by Ford Motor Company). Thus, content is categorized in the hierarchy as an element of a topic.

Note that in other embodiments, a hierarchy may include more or fewer hierarchy levels than three as in the present example (e.g., category, topic, item). Thus, content items may be defined by more or fewer identifiers than the category identifier, topic identifier, and item identifier.

Note that the category identifier, topic identifier, and item identifier for a particular content item may be determined and assigned to the content item at any time. For instance, first content 124a, second content 124b, and third content 124c may each have a corresponding item identifier assigned to them and associated with them in content storage 116 (e.g., by web service 502 of FIG. 5 or by other entity), prior to their being transmitted for display by a user device. Such an item identifier may be stored in metadata of the content item, or may be otherwise associated with the content item.

Furthermore, first content 124a, second content 124b, and third content 124c may each have a corresponding category identifier and/or topic identifier assigned to them and associated with them in content storage 116 (e.g., automatically by web service 502 of FIG. 5, by a content developer, or by other entity), prior to their being transmitted for display by a user device. Alternatively, a category identifier and/or topic identifier may be assigned and associated with a content item after being transmitted to a user device, and thus may be assigned by the user device (e.g., by action interpreter 108 of FIG. 1 or by another entity).

For instance, page 118 may have an associated category identifier and topic identifier stored in code (e.g., HTML code, XML code, etc.) of page 118. For instance, the category identifier and topic identifier may be indicated as a tag, may be included in header information, or may be otherwise included in page 118. When particular content is displayed in page 118, such as displayed content 126, the particular content may have an assigned content identifier, and may take on the category and topic identifier of page 118.

In another embodiment, the particular content may be analyzed at server 104 (e.g., by web service 502) or at user device 102 (e.g., by action interpreter 108) to determine a category and topic in which the content belongs, and to thereby select the corresponding category identifier and topic identifier for the content. For instance, in one example, displayed content 126 may include text, such as one or more words, sentences, or paragraphs. The text may be parsed for one or more keywords using one or more keyword parsing techniques that will be known to persons skilled in the relevant art(s). The keywords may be applied to a first table that lists categories on one axis, and lists keywords on another axis. The category of the column (or row) that is determined by analysis of the first table to include the most keywords found in the parsed text may be selected as the category displayed content 126. Thus, the category identifier for the selected category may be associated with displayed content 126. Similarly, using a second table that lists topics on one axis, and lists keywords on another axis may be used to determine the topic, and thereby the topic identifier, for displayed content 126. In other embodiments, other types of data structures than tables may be used to determine category and topic identifiers for content, such as arrays, data maps, etc.

In another example, displayed content 126 may include one or more images (e.g., including a video, which is a stream of images). In a similar manner as described above, the image(s) can be analyzed for keywords and/or for objects (e.g., people, trees, clothing, automobiles, consumer products, luxury items, etc.), and the determined keywords and/or objects may be compared to one or more data structures to determine category and topic identifiers for displayed content 126.

Such determinations may be performed at user device 102 and/or server 104. The determined category identifier and topic identifier may be stored in metadata of the content item, or may be otherwise associated with the content item.

Referring back to FIG. 6, in step 604 of flowchart 600, the next content to be displayed at the user device is determined based on the identified displayed content and the user preference indication. Referring to FIG. 5, in an embodiment, decision logic 508 may be configured to determine next content for display at the user device based on the identified displayed content and the user preference indication.

For instance, as shown in FIG. 5, decision logic 508 receives a user data package 510 from web service 502. User data package 510 indicates the content on which feedback was provided (e.g., displayed content 126 of FIG. 1), and indicates the feedback. In an embodiment, user data package 510 may include the category identifier, the topic identifier, and the item identifier for displayed content 126 as the identifying information. Furthermore, user data package 510 may include an indication of “No”, “More”, or “Deep”, or other suitable feedback provided by the user by interacting with displayed content 126 (e.g., a purchase of an item or service advertised by displayed content 126, subscribing to a service advertised by displayed content 126, etc.). Decision logic 508 may determine the next content for display, which may be retrieved from content storage 116, based on the identifiers and feedback. As shown in FIG. 5, decision logic 508 generates selected content indication 512, which indicates the determined next content.

For example, if an indication of “No” is received, decision logic 508 may select new content for display that is unrelated to displayed content 126. For instance, decision logic 508 may select new content from a different category than displayed content 126. If an indication of “More” is received, decision logic 508 may select new content for display that is related to displayed content 126. Decision logic 508 may select new content from a same category of content as displayed content 126, but from a same or different topic than displayed content 126. If an indication of “Deep” is received, decision logic 508 may select new content for display that is closely related to displayed content 126. For instance, decision logic 508 may select new content from a same category of content and a same topic as displayed content 126.

Referring back to FIG. 6, in step 606, the next content is provided to the user device. For instance, as shown in the example of FIG. 5, web service 502 receives selected content indication 512 from decision logic 508. Web service 502 is configured to retrieve the next content indicated in selected content indication 512 from content storage 116. Web service 502 may issue a content retrieval request 514 that identifies the next content. Content storage 116 receives content retrieval request 514, and in response thereto, accesses the next content in storage, and provides the next content to web service 502 as selected content 516. Web service 502 may transmit selected next content signal 122 from server 500, which includes the next content selected in response to content feedback signal 120. As described above, the user device (e.g., user device 102 of FIG. 1) receives selected next content signal 122 and displays the next content contained therein to the user.

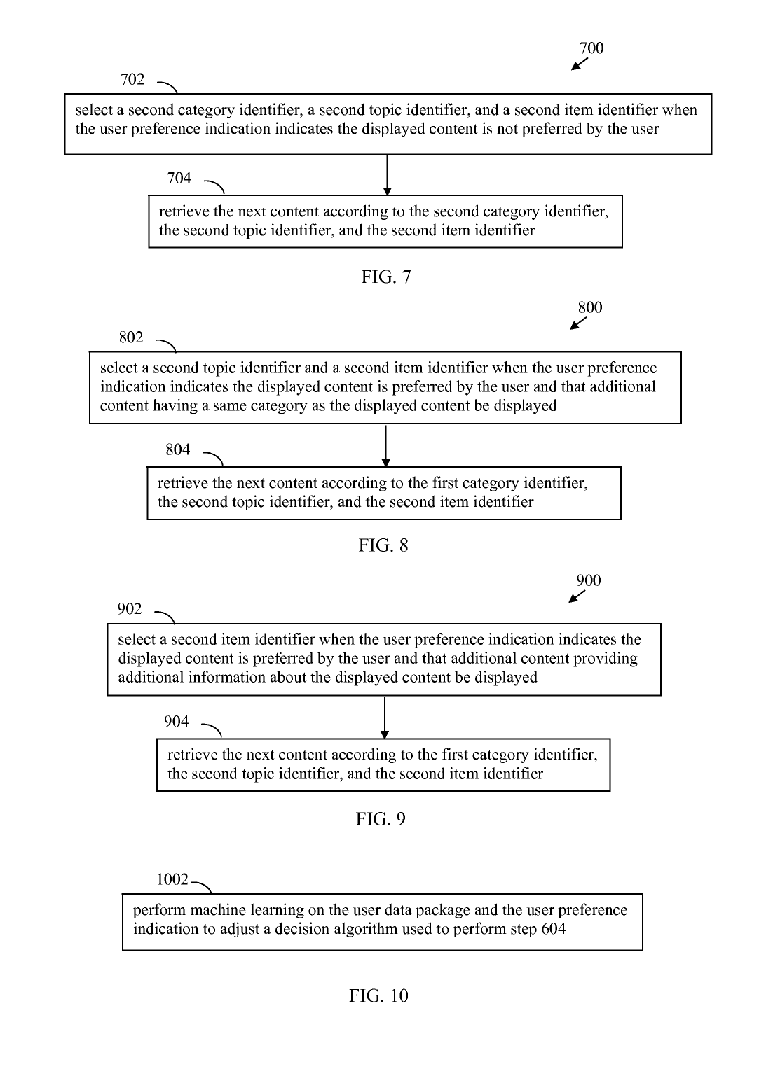

In embodiments, decision logic 508 may operate in various ways to perform step 604 of flowchart 600 (FIG. 6). In an example embodiment, decision logic 508 may operate according to FIGS. 7-9, which depict flowcharts of methods for selecting next content based on received content identifiers and user feedback. FIGS. 7-9 are described as follows.

For example, FIG. 7 depicts a flowchart 700 of a method by which a server retrieves new content based on a user indicating displayed content is not preferred, according to an embodiment. For instance, user data package 510 may include a user preference indication that indicates the user did not prefer displayed content 126 (e.g., a feedback of “No”). In such case, in step 702 of flowchart 700, a second category identifier, a second topic identifier, and a second item identifier are selected when the user preference indication indicates the displayed content is not preferred by the user. In an example, the category, topic, and item identifiers received in user data package 510 may be represented as (where “n” is an index):

CID(n)=Current category identifier

TID(n)=Current topic identifier

IID(n)=Current item identifier

In the event that the user preference indication indicates that the user did not prefer displayed content 126, each identifier may be recalculated to a next value, as represented below:

CID(n+1)=Next(CID(n))

TID(n+1)=Next(TID(n))

IID(n+1)=Next((IID(n))

where:

Next( )=a decision algorithm implemented by decision logic 508 to select next content.

In this manner, the next content may be identified by the new values for the category, topic, and item identifiers.

In step 704, the next content is retrieved according to the second category identifier, the second topic identifier, and the second item identifier. Continuing the example from step 702, in an embodiment, decision logic 508 may provide the new category, topic, and item identifiers to web service 502 in selected content indication 512, and web service 502 may retrieve the next content item identified by the new category, topic, and item identifiers from content storage 116.

FIG. 8 depicts a flowchart of a method by which a server retrieves new content based on a user indication that similar content to displayed content is desired, according to an example embodiment. For instance, user data package 510 may include a user preference indication that indicates the user did prefer displayed content 126 and wanted similar content (e.g., a feedback of “More”). In such case, in step 802 of flowchart 800, a second topic identifier and a second item identifier are selected when the user preference indication indicates the displayed content is preferred by the user and that additional content having a same category as the displayed content be displayed. In this example, the topic and item identifiers may be recalculated to next values, while the category identifier is not changed, as represented below:

CID(n+1)=CID(n)

TID(n+1)=Next(TID(n))

IID(n+1)=Next((IID(n))

In this manner, the next content may be identified by the new values for the topic and item identifiers, and the same, unchanged category identifier.

In step 804, the next content is retrieved according to the first category identifier, the second topic identifier, and the second item identifier. Continuing the example from step 802, in an embodiment, decision logic 508 may provide the unchanged category identifier and the new topic and item identifiers to web service 502 in selected content indication 512, and web service 502 may retrieve the next content item identified by these identifiers from content storage 116.

FIG. 9 depicts a flowchart of a method by which a server retrieves new content based on a user indication that content providing additional information for displayed content is desired, according to an example embodiment. For instance, user data package 510 may include a user preference indication that indicates the user did prefer displayed content 126 and wanted content more descriptive of the displayed content (e.g., a feedback of “Deep”). In such case, in step 902 of flowchart 900, a second item identifier is selected when the user preference indication indicates the displayed content is preferred by the user and that additional content providing additional information about the displayed content be displayed. In this example, the index for the item identifier may be recalculated to a next value, while the category and topic identifiers are not changed, as represented below:

CID(n+1)=CID(n)

TID(n+1)=TID(n)

IID(n+1)=Next((IID(n))

In this manner, the next content may be identified by the new value for the item identifier, and the same, unchanged category and topic identifiers.

In step 904, the next content is retrieved according to the first category identifier, the second topic identifier, and the second item identifier. Continuing the example from step 902, in an embodiment, decision logic 508 may provide the unchanged category and topic identifiers and the new item identifier to web service 502 in selected content indication 512, and web service 502 may retrieve the next content item identified by these identifiers from content storage 116.

Note that in an embodiment, machine learning and/or other learning techniques may be performed to improve decisions made by decision logic 508. For instance, as shown in FIG. 5, machine learning logic 506 may receive user data package 510. Machine learning logic 506 may use the contents of user data package 510 to improve a decision algorithm used by decision logic 506 to select next content. For instance, machine learning logic 506 may use machine learning to gradually adjust the decision algorithm to be more precise.

Machine learning logic 506 may operate according to FIG. 10. FIG. 10 depicts a step 1002 of a method for performing machine learning on user feedback provided on displayed content, according to an example embodiment. In step 1002, machine learning is performed on the user data package and the user preference indication to adjust a decision algorithm used to perform step 604.

As shown in FIG. 5, machine learning logic 506 may output a modified decision algorithm 518, which is received by decision logic 508. Modified decision algorithm 518 may be used to perform future determinations of next content.

B. Example Content Feedback Interface Embodiments

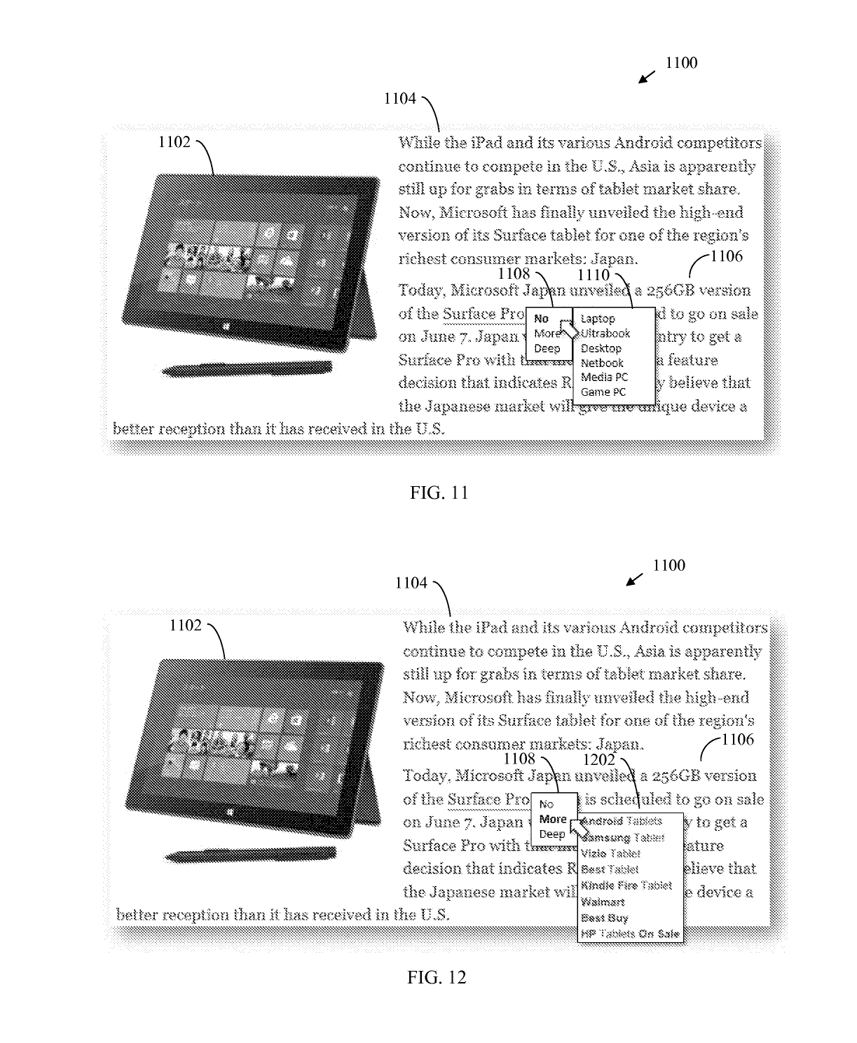

As described above, users are enabled to provide feedback directly on displayed content to cause additional content to be selected and displayed. Example techniques for providing feedback on displayed content to cause additional content to be selected and displayed are described as follows. For instance, FIGS. 11-24 show examples of displayed content, of interactions by users with the displayed content to provide feedback, and of newly displayed content selected based on the feedback, according to embodiments. FIGS. 11-24 are shown for exemplary purposes only, and are not intended to be limiting. Content may be displayed, and feedback may be provided thereon by users, in any suitable manner, as would be apparent to persons skilled in the relevant art(s) from the teachings herein. FIGS. 11-24 are described as follows.

In one set of examples, FIGS. 11-17 each show a page 1100 in which an image 1102 of a tablet computer is shown on a left side, and first and second paragraphs 1104 and 1106 of text are shown on a right side. In FIG. 11, a user interacts with an interface device (e.g., a touch pad, a mouse, etc.) to move a pointer over the text/keywords “Surface Pro” in second paragraph 1106 to interact with the keywords. For example, the user may perform a click using the interface device to cause a pop up menu 1108 to be presented over page 1100 with respect to the keywords. Pop up menu 1108 is similar to GUI element 400 of FIG. 4, and enables a user to indicate their feedback of one of “No”, “More”, or “Deep” with respect to the keywords “Surface Pro.” For instance, as shown in FIG. 11, if the user selects (e.g., clicks on, hovers over, or otherwise interacts with) the option of “No” in pop up menu 1108, indicating they do not prefer the content of “Surface Pro,” a second pop up menu 1110 (or other UI element) may be presented that enables the user to select alternative content to “Surface Pro” for display. In this example, “Surface Pro” may be categorized under the category of computers, and sub-category/topic of tablet computers. Thus decision logic 508 (FIG. 5) may select keywords for display that are under the category of computers, but related to other topics than tablets. In the example of FIG. 11, decision logic 508 may select keywords such as “Laptop”, “Ultrabook”, “Desktop”, etc., for display, which may each be selected by the user to cause additional content to be displayed.

In FIG. 12, alternatively to selecting “No”, the user may select the option of “More” in pop up menu 1108, indicating they do prefer the content of “Surface Pro,” and want to see similar keywords. As such, a third pop up menu 1202 may be presented that enables the user to select related content to “Surface Pro” for display. In this example, decision logic 508 may select keywords for display that are under the category of computers, and included in the topic of tablet computers. For instance, decision logic 508 may select keywords such as “Android Tablets”, “Samsung Tablet”, etc., for display, which may each be selected by the user to cause additional content to be displayed.

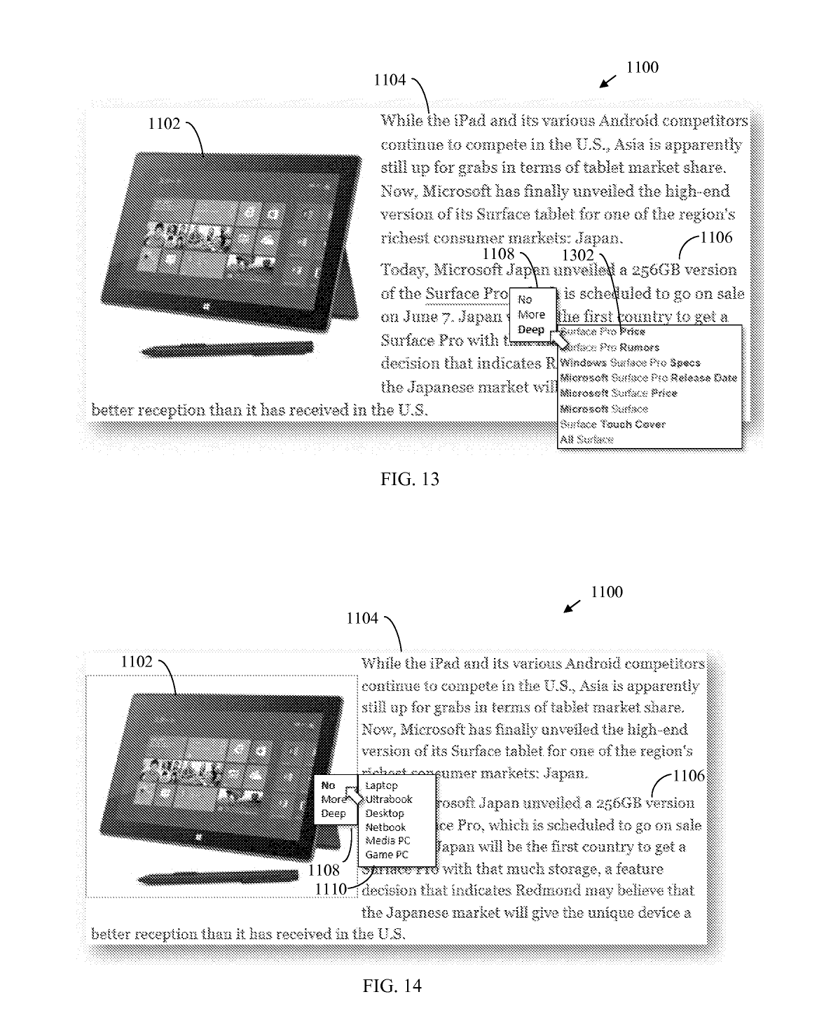

In FIG. 13, the user may instead select the option of “Deep” in pop up menu 1108, indicating they do prefer the content of “Surface Pro,” and want to see more descriptive keywords regarding “Surface Pro”. As such, a fourth pop up menu 1302 may be presented that enables the user to select more descriptive content to “Surface Pro” for display. In this example, decision logic 508 may select keywords for display that are under the category of computers, and topic of tablet computers, and more descriptive of “Surface Pro.” For instance, decision logic 508 may select keywords such as “Surface Pro Price”, “Surface Pro Rumors”, etc., for display, which may each be selected by the user to cause additional content to be displayed.

In the example of FIGS. 14-16, the user interacts with image 1102 to provide feedback by moving a pointer over image 1102. The user may perform a click using the interface device to cause pop up menu 1108 to be presented over page 1100 with respect to image 1102. In FIG. 14, the user selects the option of “No” in pop up menu 1108, indicating they do not prefer the content of image 1102. As such, second pop up menu 1110 may be presented that enables the user to select alternative content to image 1102 for display. In this example, image 1102 shows a Microsoft® Surface Pro™ computing device, and thus image 1102 may be categorized under the category of computers, and under the sub-category/topic of tablet computers. Thus decision logic 508 (FIG. 5) may select other computers for listing in pop up menu 1110 that are under the category of computers, but related to other topics than tablets. In the example of FIG. 14, decision logic 508 may select “Laptop”, “Ultrabook”, “Desktop”, etc., for display, which may each be selected by the user to cause additional content to be displayed.

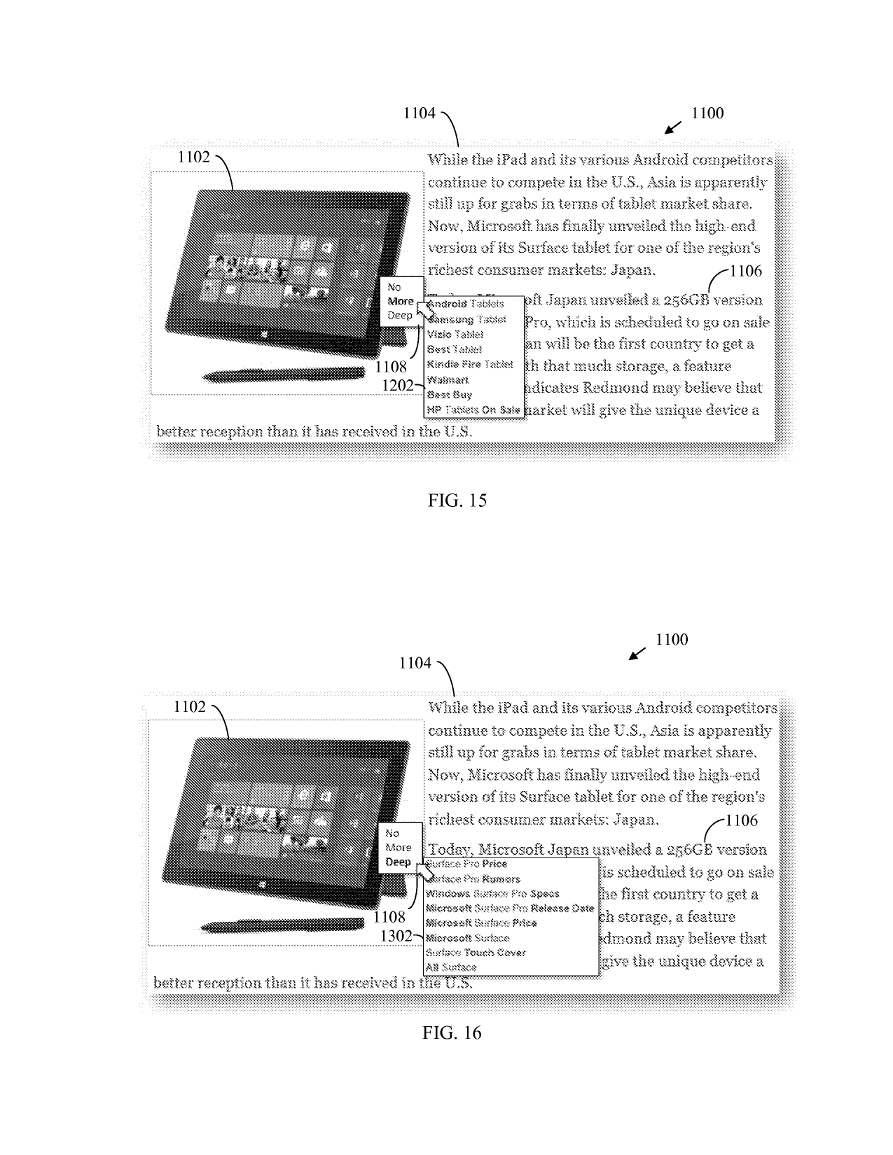

In FIG. 15, the user may instead select the option of “More” in pop up menu 1108, indicating they do prefer image 1102, and want to see similar content. As such, third pop up menu 1202 may be presented that enables the user to select related content to image 1102 for display. In this example, decision logic 508 may select images or other content for display that are under the category of computers, and included in the topic of tablet computers. For instance, decision logic 508 may list names of content such as “Android Tablets”, “Samsung Tablet”, etc., for display, which may each be selected by the user to cause additional content to be displayed.

In FIG. 16, the user may instead select the option of “Deep” in pop up menu 1108, indicating they do prefer image 1102 and want to see more descriptive content regarding image 110. As such, fourth pop up menu 1302 may be presented that enables the user to select content that is more descriptive of image 1102 for display. In this example, decision logic 508 may select images or other content for display that are under the category of computers, and topic of tablet computers, and more descriptive of image 1102. For instance, decision logic 508 may select content having names such as “Surface Pro Price”, “Surface Pro Rumors”, etc., for display, which may each be selected by the user to cause additional content to be displayed.

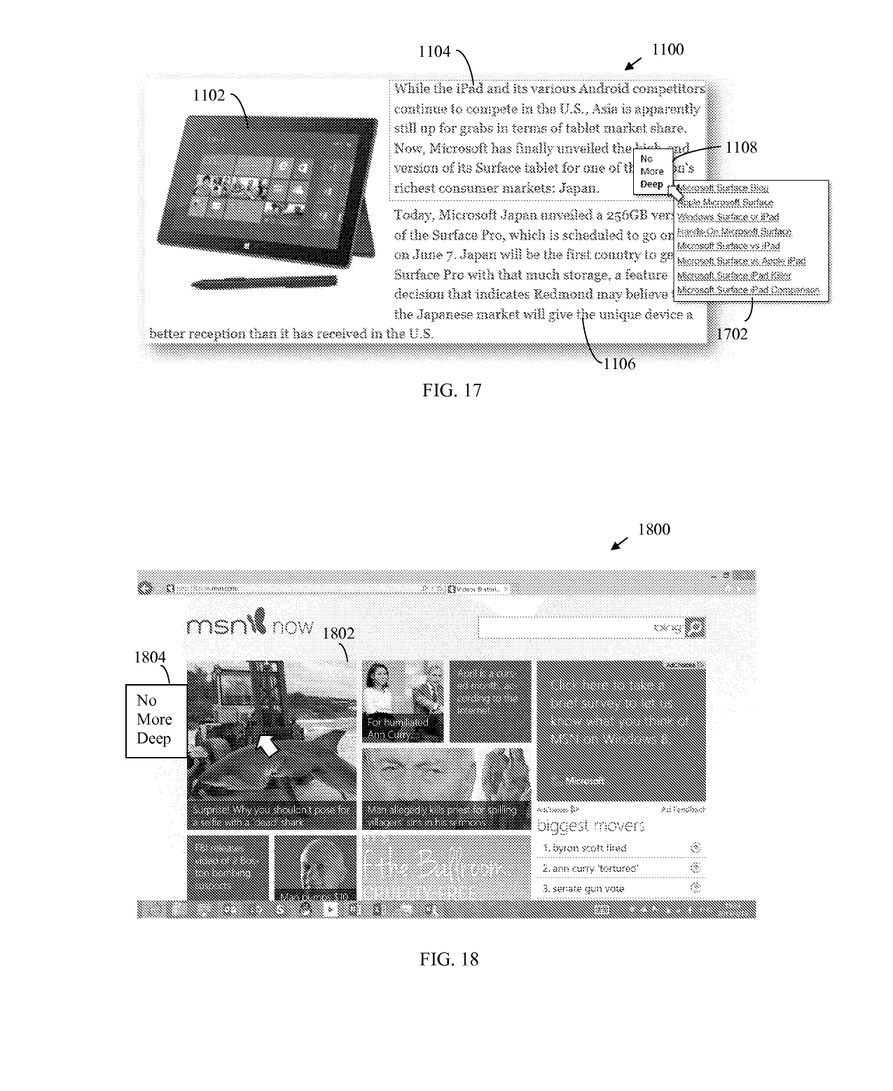

In FIG. 17, the user interacts with first paragraph 1104 to provide feedback by moving a pointer over first paragraph 1104. The user may perform a click using the interface device to cause pop up menu 1108 to be presented over page 1100 with respect to first paragraph 1104. In FIG. 14, the user selects the option of “Deep” in pop up menu 1108, indicating they do prefer first paragraph 1104 and want to see more descriptive content regarding first paragraph 1104. As such, a fifth pop up menu 1702 may be presented that enables the user to select content that is more descriptive of first paragraph 1104 for display. In this example, web service 502, decision logic 508, action interpreter 108, or other entity may analyze text of first paragraph 1104, such as by parsing the text as described above, to determine a category and topic of first paragraph 1104. For instance, computers may be determined as a category of first paragraph 1104, and Microsoft® Surface™ may be determined as the topic of first paragraph 1104. As such, decision logic 508 may select images or other content for display that are under the category of computers, and topic of Microsoft® Surface™, and are more descriptive of first paragraph 1104. For instance, decision logic 508 may select content having names such as “Microsoft Surface Blog”, “Apple Microsoft Surface”, etc., for display, which may each be selected by the user to cause additional content to be displayed.

In a similar manner as described above, the “No” and “More” options may be selected in pop up menu 1108 in FIG. 17 to cause additional content to be selected for display.

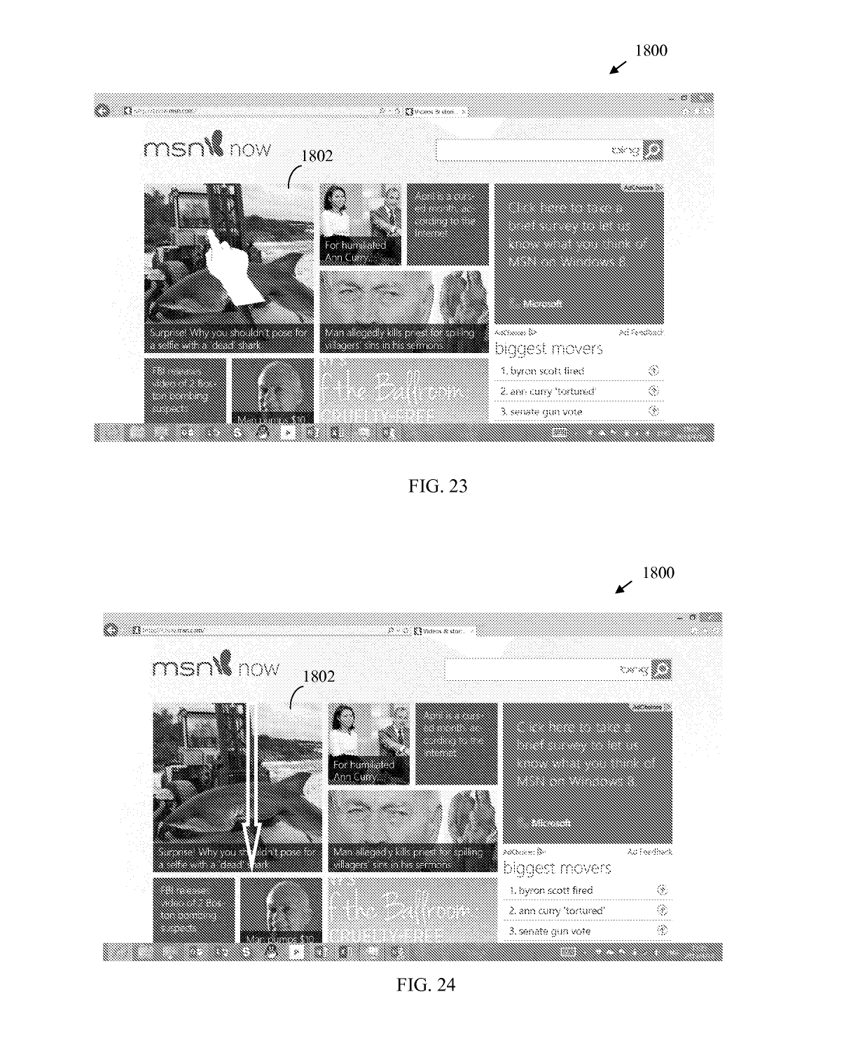

In another set of examples, FIGS. 18-24 each show a page 1800 in which various forms of content are present, including text and images. A first image 1802 is present in an upper left corner of page 1800 that shows a picture of a shark and includes a textual caption of “Surprise! Why you shouldn't pose for a selfie with a ‘dead’ shark.” FIGS. 18-24 show examples of interactions with image 1802 to provide feedback, and examples of next content selected based on the feedback. FIGS. 18-22 relate to non-touch embodiments for providing feedback, FIGS. 23 and 24 relate to touch embodiments for providing feedback.

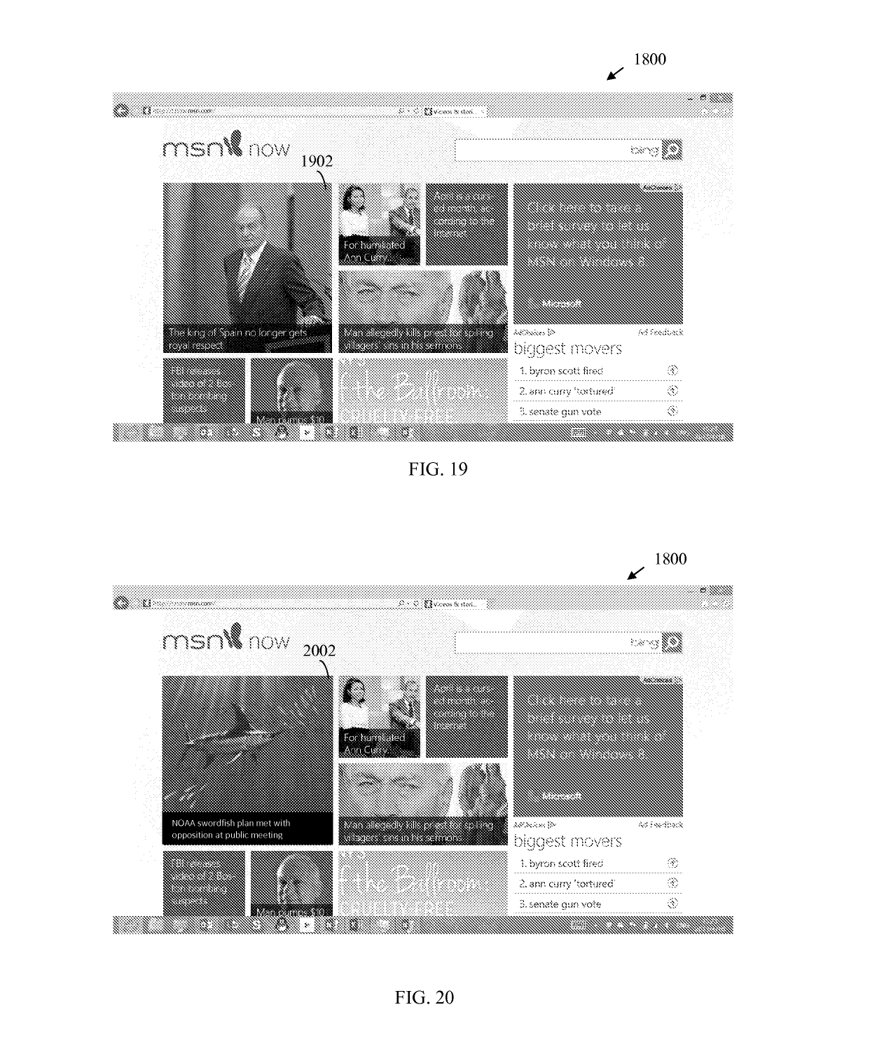

In FIG. 18, a user interacts with an interface device (e.g., a touch pad, a mouse, etc.) to move a pointer over image 1802 to provide feedback on image 1802. For example, the user may perform a click using the interface device to cause a pop up menu 1804 to be presented over page 1800 with respect to image 1802. Pop up menu 1804 is similar to GUI element 400 of FIG. 4, and enables a user to indicate their feedback of one of “No”, “More”, or “Deep” with respect to image 1802. For instance, as shown in FIG. 18, if the user selects the option of “No” in pop up menu 1804, indicating they do not prefer the content of “image 1802, replacement content for image 1802 may be automatically selected and displayed in place of image 1802. In this example, image 1802 may be categorized under the category of news, with a sub-category/topic of sea life. Thus decision logic 508 (FIG. 5) may select content for display that is under the category of news, but related to other topics than sea life. For instance, FIG. 19 shows page 1800 with an image 1902 displayed in place of image 1802. Image 1902 is displayed in the same position in page 1800 as was image 1802, and has a same size as image 1802. However, image 1902 is categorized under the category of news and topic of international (showing the king of Spain), and thus relates to a different topic than image 1802.

Alternatively in FIG. 18, the user may select the option of “More” in pop up menu 1802, indicating they do prefer image 1802, and want to see similar content. As such, similar content to image 1802 may be automatically selected and displayed in place of image 1802. Thus, decision logic 508 (FIG. 5) may select content for display that is categorized under the category of news and the topic of sea life. For instance, FIG. 20 shows page 2000 with an image 2002 displayed in place of image 1802. Image 2002 is displayed in the same position in page 1800 as was image 1802, and has a same size as image 1802. Image 2002 is categorized under the category of news and the topic of sea life (showing a swordfish), and thus relates to a same topic as image 1802.

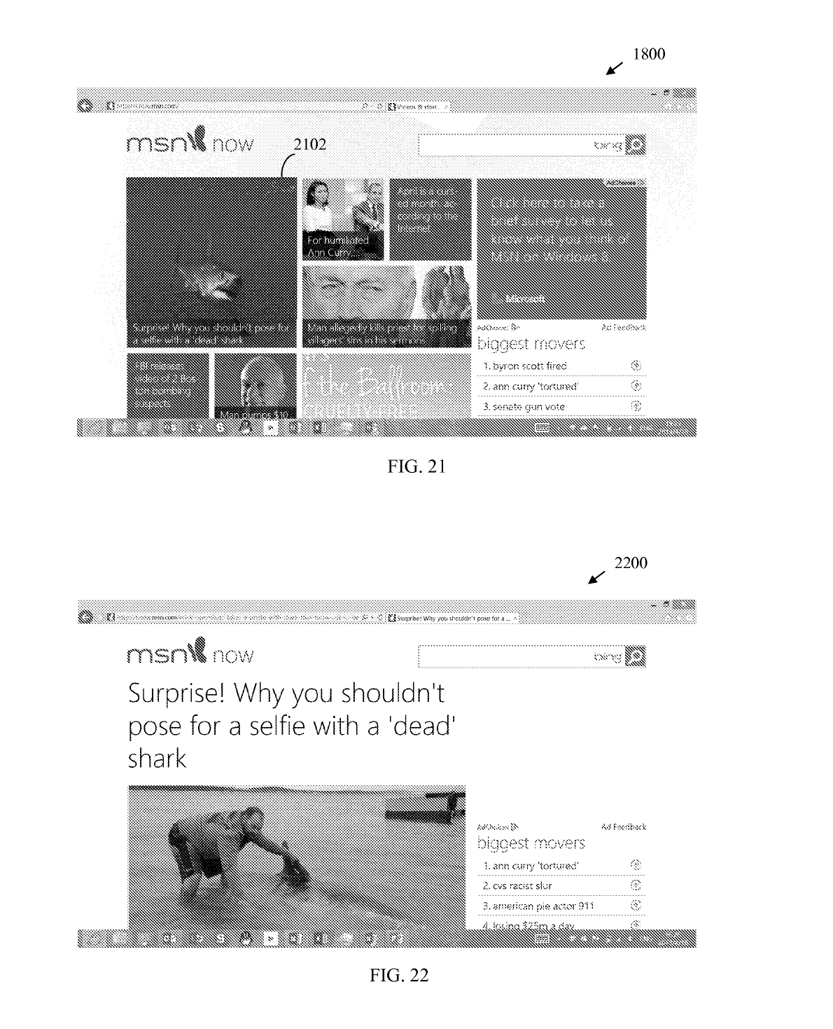

In another case, the user may select the option of “Deep” in pop up menu 1802, indicating they do prefer image 1802, and want to see more descriptive content. As such, content more descriptive of image 1802 may be automatically selected and displayed in place of image 1802. Thus, decision logic 508 (FIG. 5) may select content for display that is categorized under the category of news and the topic of sea life, and is descriptive of the content of image 1802 (e.g., sharks). For instance, FIG. 21 shows page 2100 with an image 2102 displayed in place of image 1802. Image 2102 is displayed in the same position in page 1800 as was image 1802, and has a same size as image 1802. Image 2102 is categorized under the category of news and the topic of sea life, showing a shark, and thus shows content that is descriptive of the content of image 1802.

It is noted that in an alternative embodiment, rather than displaying selected content in place of displayed content, the selected content may be displayed in another location, including a page that is different from the page of the displayed content. For instance, when the user selects the option of “Deep” in pop up menu 1802 in FIG. 18, a new page 2200 shown in FIG. 22 may be displayed that shows selected content categorized under the category of news and the topic of sea life, and that is descriptive of the content of image 1802. Page 2200 shows an image and text that relates to a person posing for a picture with a shark, and thus shows content that is descriptive of the content of image 1802.

Furthermore, it is noted that the interactions with image 1802 with or without pop up menu 1804 may be performed using touch, motion sensing, speech recognition, or other feedback interface techniques. For instance, FIG. 23 shows a user that touches a display screen at a location of image 1802 in page 1800 to provide feedback on image 1802, as represented by a transparent hand in FIG. 23. The user may touch the screen in any manner, according to any pattern, to convey a selection of “No,” “More,” or “Deep” with respect to image 1802. For instance, the user may touch an upper portion of image 1802 in page 1800 to indicate “No,” may touch a left side portion of image 1802 in page 1800 to indicate “More,” or may touch a central portion of image 1802 in page 1800 to indicate “Deep.” In touch embodiments, any combination of touching, including finger touches/taps, dragging/swiping of fingers, double tapping or additional taps, etc., may be used to indicate selections by the user.

For instance, FIG. 24 shows an example of a finger being dragged downward on page 1800 over content 1802 to indicate “No”. Similarly, a rightward drag of a finger over content 1802 may indicate “More”, and a tap on content 1802 may indicate “Deep.”

Thus, user feedback on content may be provided in various ways, and using any combinations of feedback techniques, including combinations of touch, non-touch, motion sensing of gestures, voice, etc.

In a non-touch example, “No” and “More” may be represented by displaying clickable buttons when a pointer is hovered over content, and “Deep” may be represented by a mouse click on the content.

In a touch example, “No” may be represented by a swipe up/down, “More” may be represented by a swipe left/right, and “Deep” may be represented by tapping on the content.

In motion example (e.g., using a Microsoft® Kinect™ device), “No” may be represented by waving your hand(s) up/down, “More” may be represented by waving your hand(s) left/right, and “Deep” may be represented by holding your hand(s) in a fist.

In a gesture example (e.g., using a Microsoft® Kinect™ device), “No” may be represented by a user shaking their head, “More” may be represented by the user nodding their head, and “Deep” may be represented by the user smiling.

In a voice example, “No” may be represented by a user saying “No,” “More” may be represented by the user saying “More,” and “Deep” may be represented by the user saying “Deep.”

In a combination interaction example, “No” may be represented by a user shaking their head (gesture), “More” may be represented by the user saying “More” (voice), and “Deep” may be represented by the user tapping on the displayed content (touch).

Note that these examples are provided for purposes of illustration, and are not intended to be limiting. It will be apparent to persons skilled in the relevant art(s) based on the teachings herein that any way of providing feedback, and combinations thereof, may be used.

### III. Example Incentive System Based on User Feedback

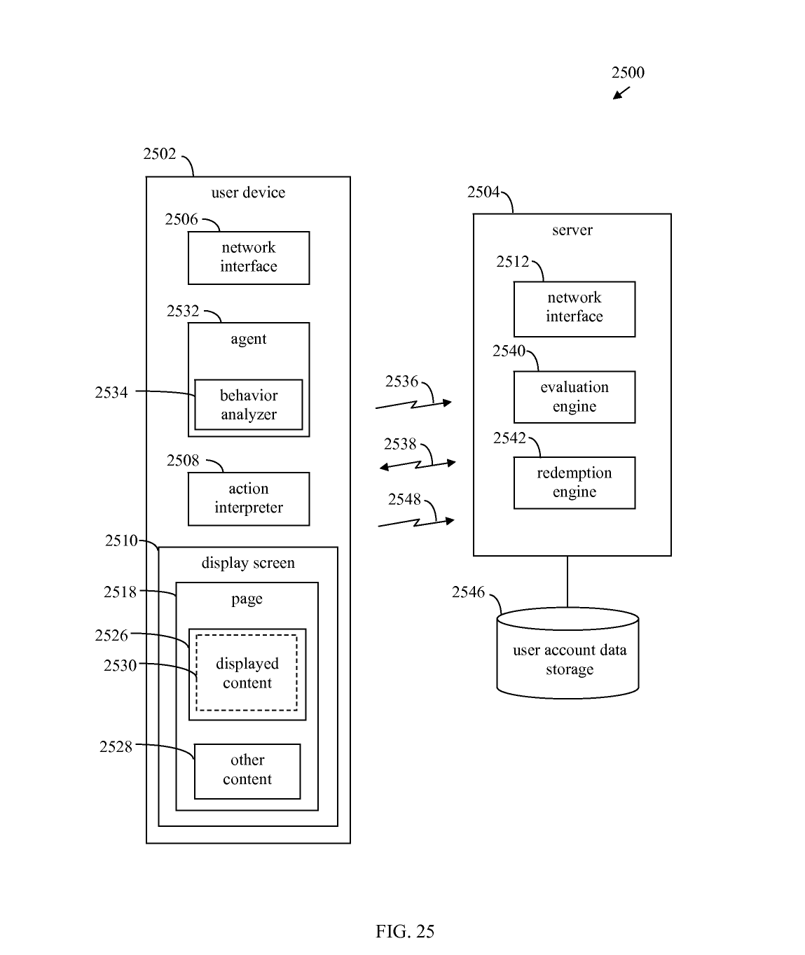

Embodiments of a system that incentives users to provide feedback about, consume, and/or interact with content will now be described. Such an incentive system may be implemented in devices and servers in various ways. For instance, FIG. 25 is a block diagram of an incentive system 2500 according to an example embodiment. In system 2500, information concerning feedback provided by a user with respect to content displayed on a user device 2502 is transmitted to a server 2504 where it is used to determine the value of an incentive that is then awarded to the user. As shown in FIG. 25, user device 2502 includes a network interface 2506, an action interpreter 2508, and a display screen 2510. Server 2504 includes a network interface 2512, an evaluation engine 2540, and a redemption engine 2542. Server 2504 includes or is coupled to user account data storage 2546.

User device 2502 may be any type of stationary or mobile computing device, including a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone (e.g., a cell phone, a smart phone such as a Microsoft Windows® phone, an Apple iPhone, a phone implementing the Google® Android™ operating system, a Palm® device, a RIM Blackberry® device, etc.), a wearable computing device (e.g., a smart watch, smart glasses such as Google® Glass™, etc.), or other type of mobile device (e.g., an automobile), or a stationary computing device such as a desktop computer or PC (personal computer). Server 2504 may be implemented in one or more computer systems (e.g., servers), and may be mobile (e.g., handheld) or stationary. Server 2504 may be considered a “cloud-based” server, may be included in a private or other network, or may be considered network accessible in another way.

User account data storage 2546 may include one or more of any type of storage mechanism to store user account data in the form of files or other form, including a magnetic disc (e.g., in a hard disk drive), an optical disc (e.g., in an optical disk drive), a magnetic tape (e.g., in a tape drive), a memory device such as a RAM device, a ROM device, etc., and/or any other suitable type of storage medium.

Network interface 2512 of server 2504 enables server 2504 to communicate over one or more networks, and network interface 2506 of user device 2502 enables user device 2502 to communicate over one or more networks. Examples of such networks include a local area network (LAN), a wide area network (WAN), a personal area network (PAN), or a combination of communication networks, such as the Internet. Network interfaces 2506 and 2512 may each include one or more of any type of network interface (e.g., network interface card (NIC)), wired or wireless, such as an as IEEE 802.11 wireless LAN (WLAN) wireless interface, a Worldwide Interoperability for Microwave Access (Wi-MAX) interface, an Ethernet interface, a Universal Serial Bus (USB) interface, a cellular network interface, a Bluetooth™ interface, a near field communication (NFC) interface, etc.

Display screen 2510 of user device 2502 may be any type of display screen, such as an LCD (liquid crystal display) screen, an LED (light emitting diode) screen such as an organic LED screen, a plasma display screen, or other type of display screen. Display screen 2510 may be integrated in a single housing of user device 2502, or may be a standalone display. As shown in FIG. 25, display screen 2510 may be used to display content at user device 2502. For instance, a user of user device 2502 may interact with a user interface of user device 2502 to browse content, and cause content to be displayed by display screen 2510. For instance, content may be displayed by display screen 2510 that is contained in a page 2518, such as a web page rendered by a web browser, or content may be displayed in another form by another application.

As shown in FIG. 25, display screen 2510 may display displayed content 2526 and other content 2528. Displayed content 2526 and other content 2528 may each include one or more content items in the form of textual content or image content. In the example of FIG. 25, displayed content 2526 is configured to be able to be interacted with by a user of user device 2502 to provide feedback on displayed content 2526, according to an embodiment. For example, as shown in FIG. 25, displayed content 2526 may include a feedback interface 2530 that enables a user to provide feedback on displayed content 2526, such as by mouse clicks (e.g., on a displayed pop up menu, one or more virtual buttons, etc.), by touching display screen 2510, by motion sensing, by speech recognition, and/or by other user interface interaction. Other content 2528 may optionally be present, and may also be configured to be interacted with by a user to provide feedback thereon, or may not be configured to provide feedback.

Action interpreter 2508 is configured to interpret the feedback of the user provided with respect to displayed content 2526 using feedback interface 2530. For example, as described elsewhere herein, the user may provide feedback with respect to displayed content 2526 in the form of not preferring displayed content 2526 (e.g., not wanting to view displayed content 2526, but wanting to display alternative content instead), referred to herein as a feedback selection of “No”; preferring displayed content 2526 and wanting to view additional similar content, referred to herein as a feedback selection of “More”; and preferring displayed content 2526 and wanting to view additional content that is more descriptive of displayed content 2526 and/or conduct a transaction with respect to displayed content 2526, referred to herein as a feedback selection of “Deep”. Action interpreter 2508 is configured to receive the feedback provided to feedback interface 2530 by the user, and provide the feedback to network interface 2506 to be transmitted to server 2504.

User device 2502 may operate in accordance with the previously-described method of flowchart 200 to enable a user to provide feedback directly on displayed content at user device 2502, according to an example embodiment. Furthermore, a user can interact with user device 2502 in accordance with the previously-described method of flowchart 300 to indicate various preferences with respect to displayed content. Thus, a user is enabled to interact with the displayed content to indicate a first preference that the displayed content is not preferred and be replaced with a display of a replacement content, to interact with the displayed content to indicate a second preference that the displayed content is preferred and that additional content regarding a same topic as the displayed content be displayed, and to interact with the displayed content to indicate a third preference that the displayed content is preferred and that additional content providing additional information about the displayed content be displayed.

Feedback interface 2530 may be configured to enable the user to provide their feedback in any suitable form, including by one or more of mouse clicks, touch, motion, voice, etc. For instance, previously-described GUI element 400 may be used to enable a user to indicate various preferences with respect to displayed content, according to an embodiment. Furthermore, a user may provide feedback via any of the feedback mechanisms described above in relation to FIGS. 11-24 or using different mechanisms. Feedback may be provided explicitly in the sense that the user is aware that he/she is providing feedback (e.g., by actively selecting one of “No,” “More,” or “Deep”) or may be provided implicitly in the sense that the user is not aware that his/her actions constitute a form of feedback (e.g., a user interaction with a display ad for the purpose of purchasing something may be interpreted as “Deep”).

In an embodiment, network interface 2506 of user device 2502 may transmit to a server a content feedback signal that indicates the feedback provided by the user with respect to displayed content 2526 and received by action interpreter 2508. The server may use such content feedback signal to select next content to be displayed for displayed content 2526 based on the feedback received in the content feedback signal. The server that performs this function may be a server such as server 104 as described above in reference to FIG. 1 or server 500 as described above in reference to FIG. 5. Such server may operate in a manner described above in reference to those embodiments to select next content to be displayed for displayed content 2526 based on the feedback received in the content feedback signal. Alternatively, server 2504 may itself include similar components to those included in server 104 or server 500 and thus perform like operations to select next content to be displayed for displayed content 2526 based on the feedback received in the content feedback signal.

In this manner, a user of user device 2502 is enabled to provide content-specific feedback on content that may be displayed in a screen/page side-by-side with other content. Furthermore, the feedback may be more than a mere like/dislike type of content, but can also indicate further types of content that the user may desire to be displayed (e.g., different content, similar content, content that is more descriptive, etc.). Still further, the content that is selected in response to the feedback may be displayed in place of the displayed content that the feedback was provided on. Thus, a portion of a displayed page/screen may be changed based on user feedback, while the rest of the page/screen does not change.

As further shown in FIG. 25, user device 2502 includes an agent 2532. Agent 2532 comprises logic that exists or is installed upon user device 2502 to enable a user of user device 2502 to participate in an incentive program that incentivizes the user to provide feedback about, consume, and/or interact with displayed content, such as displayed content 2526 or other content 2528. In an embodiment in which agent 2532 comprises a computer program, agent 2532 may be installed on user device 2502 in a variety of ways. For example, agent 2532 may be installed during manufacturing of user device 2502. Alternatively, agent 2532 may be installed after manufacturing of user device 2502 by downloading software from a remote entity (e.g., server 2504) via a network. Such downloading and installation may occur, for example, when a user first signs up for the incentive program. Still other methods may be used to install agent 2532 on user device 2502. Agent 2532 may comprise, for example and without limitation, a stand-alone application, a plug-in or part of some other program or application (e.g., a part or plug-in of a Web browser), or a part of an operating system 2502 of user device.

Agent 2532 operates to monitor and track feedback provided by the user of user device 2502 with respect to different items of content (e.g., displayed content 2526 and other content 2528). To this end, agent 2532 may receive information from action interpreter 2508 concerning the feedback provided by the user of user device 2502 with respect to different items of content. A behavior analyzer 2534 within agent 2532 may then analyze this information to generate measures that are transmitted to server 2504 via network interface 2506. In an embodiment, agent 2532 comprises a background process that executes in a transparent manner as the user is browsing content and providing feedback about such content. Such a background process may be launched, for example, as part of a start-up process that occurs when user device 2502 is powered on or when a particular application or process (e.g. a Web browser) is launched. However, this example is not intended to be limiting, and agent 2532 need not be implemented as a background process.

In one embodiment, behavior analyzer 2534 determines how many instances of each of a set of predefined feedback types the user has provided with respect to various items of content over a certain time period. The time period may, be for example, the time during which the user is involved in a browsing session or some other suitable timespan. For example, with respect to the previously-described model UI, behavior analyzer 2534 may determine how many instances of each of the following types of feedback the user has provided with respect to various items of content over a certain time period: (a) the number of “No” instances, each of which may indicate that the user dislikes a particular category of content, a particular brand, and/or a particular content item; (b) the number of “More” instances, each of which may indicate that the user likes a particular category of content, a particular brand, and/or a particular content item and wishes to see additional content dealing with similar subject matter (e.g., the same brand or the same category and/or topic of content); and (c) the number of “Deep” instances, each of which may indicate that the user wants to see additional information about a particular content item or wants to conduct a transaction with respect to the particular content item.

Agent 2532 transmits the measures generated by behavior analyzer 2534 via network interface 2506 as part of a feedback measures signal 2536. Server 2504 receives feedback measures signal 2536 via network interface 2512. Server 2504 includes an evaluation engine 2540 that utilizes the measures included in feedback measures signal 2536 to determine one or more incentives that will be awarded to the user as part of the incentive program. Evaluation engine 2540 then awards the incentives to the user by assigning the incentives to a user account associated with the user. This may be carried out by storing information about the incentives to be awarded to the user in association with the user account. Such information may be stored, for example, in user account data storage 2546.

Any of a wide variety of incentives may be awarded to the user, including both tangible and intangible incentives. For example and without limitation, the incentives may include money, goods, services, redeemable vouchers for goods or services, coupons for discounts on goods and services, honors, titles, enhanced program participation benefits, or the like. In one embodiment, the incentives comprise credits that can subsequently be redeemed by the user to obtain one or more tangible or intangible items of value.

Server 2504 also includes a redemption engine 2542. Redemption engine 2542 is configured to enable a user to identify and redeem the incentives that have been awarded to him/her by evaluation engine 2540. To this end, redemption engine 2542 has access to user account data for the user that includes an indication of any incentives that have been awarded to the user. As previously noted, such user account data may be stored in user account data storage 2546.

In an embodiment, redemption engine 2542 can be accessed by the user via a user interface of user device 2502 (or other device accessible to the user) that enables the user to interact with redemption engine 2542 to obtain access to his/her incentives. Such interaction is denoted by the bi-directional arrow marked with reference numeral 2538 in FIG. 25. In an embodiment in which the incentives comprise credits, the user can interact with redemption engine 2542 to determine how many credits he/she has accumulated and to redeem such credits for one or more items of value.

In a scenario in which an incentive is to be sent to the user, the user can interact with redemption engine 2542 to select a suitable channel for delivery. If the incentive comprises physical goods, selecting a suitable channel may include, for example, providing shipping instructions. If the incentive comprises a voucher or coupon, selecting a suitable channel may comprise selecting to receive the incentive in paper or electronic form. If an incentive is to be received in electronic form, selecting a suitable channel may comprise selecting to receive the incentive via a browser (e.g., as part of a Web page) or other Web-enabled application, via e-mail, via an SMS message, or the like.

In one embodiment, redemption engine 2542 is configured to serve one or more Web pages to a browser or other program running on user device 2502 (or other device accessible to the user) via which the user can interact with redemption engine 2542 to identify and/or redeem his/her incentives. In an alternate embodiment, an application or other computer program may be installed on user device 2502 (or other device accessible to the user) that, when executed, enables the user to interact with redemption engine 2542 to identify and/or redeem his/her incentives. Still other mechanisms may be used for facilitating interaction between the user and redemption engine 2542.

In an embodiment, evaluation engine 2540 determines the value of an incentive to be awarded to the user based on a type or types of feedback provided by the user with respect to content. That is to say, the value of the incentive that will be awarded to a user will vary based on the type or types of feedback that the user has provided with respect to content. For this to occur, the feedback provided by the user with respect to content must be classifiable into one of a plurality of predefined feedback types. An example of such a classification was provided above with respect to the model UI of Section II—namely, a “No” feedback type, a “More” feedback type, and a “Deep” feedback type. However, this is only one example, and user feedback about content may be classified into a wide variety of other arbitrarily-defined types (e.g., “like” and “dislike”; “highly interested,” “mildly interested” and “not interested”; a rating or grading system; etc.).

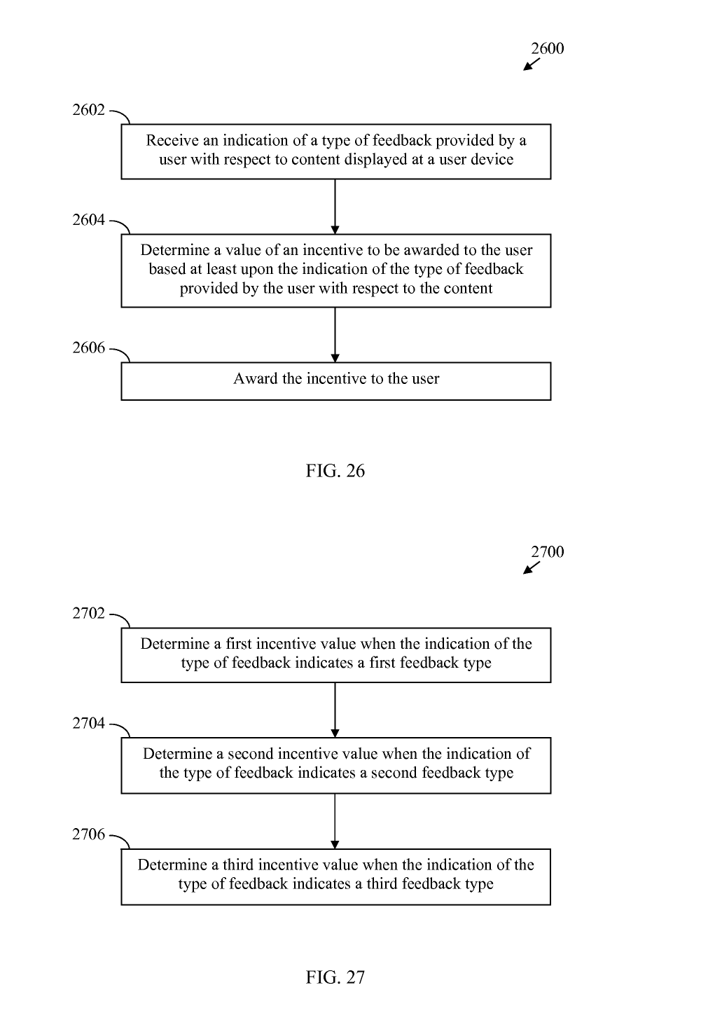

FIG. 26 depicts a flowchart 2600 of a method by which server 2504 may operate to determine a value of an incentive based upon a type of content feedback provided by a user and to award the incentive to the user. Although the method of flowchart 2600 will now be described with continued reference to components of incentive system 2500, persons skilled in the relevant art(s) will appreciate that the method may be implemented by other components or systems.

As shown in FIG. 26, the method of flowchart 2600 begins at step 2602, in which an indication of a type of feedback provided by a user with respect to content displayed at a user device is received. This step may be performed, for example, by network interface 2512 of server 2504 when network interface 2512 receives feedback measures signal 2536. As was previously described, feedback measures signal 2536 may include an indication of how many instances of each of a plurality of predefined feedback types the user has provided with respect to various items of content over a certain time period. However this is only an example, and the indication received during step 2602 may be represented in other forms. For example, the indication received during step 2602 may simply indicate that the user has provided a particular type of feedback with respect to a single item of content.

At step 2604, a value of an incentive to be awarded to the user is determined based at least upon the indication of the type of feedback provided by the user with respect to the content. This step may be performed, for example, by evaluation engine 2540.

At step 2606, the incentive is awarded to the user. This step may also be performed, for example, by evaluation engine 2540. Evaluation engine 2540 may award the incentive to the user by assigning the incentive to a user account associated with the user. However, the awarding of the incentive to the user may be carried out using other techniques as well. For example, the incentive itself or information sufficient to redeem the incentive may simply be sent to the user via any one of a variety of physical or digital communication channels.

As noted above, the value of the incentive determined during step 2604 is determined based at least upon the indication of the type of feedback provided by the user with respect to the content. In one embodiment, a different incentive value is determined depending on the type of feedback that was provided by the user. For example, in an embodiment in which there are three feedback types comprising “No,” “More” and “Deep,” an instance of “Deep” feedback may result in the assignment of a greater incentive value than an instance of “More” feedback, and an instance of “More” feedback may result in the assignment of a greater incentive value than an instance of “No” feedback. One reason for valuing the feedback in this manner is that “Deep” feedback is likely to be more valuable than “More” feedback in determining a user's preferences, and “More” feedback is likely to be more valuable than “No” feedback” in determining the user's preferences. For example, when a user provides a feedback of “Deep,” the system can determine exactly what the user likes and deliver the precise content in which the user is interested. When a user provides a feedback of “More,” the system can obtain a better sense of what the user likes at some level of generality (e.g., category or topic) and can therefore fetch new content in which the user is likely to be interested. When a user provides a feedback of “No,” the system can only exclude content that the user doesn't like but gains only limited knowledge about what the user does like. In every case, the knowledge obtained through feedback can be used to model the preferences of the user and such model may be stored in a user profile for later use.

In an embodiment in which the incentives comprise credits that accrue to a user account, a different multiplier or coefficient may be assigned to each feedback type. The coefficient for a particular feedback type can be multiplied by the number of instances of the particular feedback type provided by the user over a certain time period (as conveyed in feedback measures signal 2536) to determine a number of credits that should be added to the user's user account. A scheme such as that shown below in Table 1 may be used to evaluate the number of credits to be awarded.

TABLE 1

| | Coef- | |
|---|---|---|
| Behavior | ficient | Explanation |
| No | 1x | When user selects “No,” the system can only |
| | | exclude content the user does not like but has |
| | | limited knowledge about what the user does like |
| More | 2x | When user selects “More,” the system has a better |
| | | knowledge of what the user likes and can fetch |
| | | new content in which the user is likely to be |
| | | interested |
| Deep | 3x | When user selects “Deep,” the system can |
| | | determine exactly what the user likes and deliver |
| | | the precise content in which the user is interested |

For example, in accordance with the scheme shown in Table 1, if the measures received as part of feedback measures signal 2536 indicate that a user has provided 7 “No” types of feedback, 3 “More” types of feedback, and 1 “Deep” type of feedback during a particular time period, evaluation engine 2540 may determine that the user should be awarded (1×7)+(2×3)+(3×1)=16 credits. Of course, this scheme is provided by way of example only. Persons skilled in the relevant art(s) will appreciate that any number of schemes may be developed to determine the value of an incentive based on feedback type.

To further illustrate some of the foregoing concepts, FIG. 27 depicts a flowchart of a method 2700 for determining a value of an incentive to be awarded to a user based at least upon on indication of a type of feedback provided by the user with respect to content. In one embodiment, the method of flowchart 2700 is performed by evaluation engine 2540 within system 2500. However, persons skilled in the relevant art(s) will appreciate that the method may be implemented by other components or systems.

As shown in FIG. 27, the method of flowchart 2700 begins at step 2702 in which a first incentive value is determined when the indication of the type of feedback indicates a first feedback type. By way of example, a first incentive value may be determined when the indication of the type of feedback indicates a “No” feedback type.

At step 2704, a second incentive value is determined when the indication of the type of feedback indicates a second feedback type. By way of example, a second incentive value may be determined when the indication of the type of feedback indicates a “More” feedback type.

At step 2706, a third incentive value is determined when the indication of the type of feedback indicates a third feedback type. By way of example, a third incentive value may be determined when the indication of the type of feedback indicates a “Deep” feedback type.

In an embodiment, the third incentive value is greater than the second incentive value and the second incentive value is greater than the first incentive value. Thus, in accordance with this embodiment and the specific examples mentioned above, the third incentive value assigned to the “Deep” type of feedback exceeds the value of the second incentive value assigned to the “More” type of feedback, and the second incentive value assigned to the “More” type of feedback exceeds the value of the first incentive value assigned to the “No” type of feedback. One way of achieving the foregoing in an embodiment in which the incentive comprises credits is to multiply the instance of feedback by a coefficient wherein the coefficient assigned to “Deep” feedback is larger than the coefficient assigned to “More” feedback, and the coefficient assigned to “More” feedback is larger than the coefficient assigned to “No” feedback. Such an approach was described above in reference to Table 1.

In a further embodiment, evaluation engine 2540 determines the value of an incentive to be awarded to the user based on a type of feedback provided by the user with respect to various items of content and a category associated with each item of content about which the feedback was provided. That is to say, the value of the incentive that will be awarded to a user will vary based on the type of feedback that the user has provided with respect to various items of content and a category associated with each item of content about which the feedback was provided. For this to occur, the feedback provided by the user with respect to content must be classifiable into one of a plurality of predefined feedback types (e.g., “No,” “More” and “Deep” as was previously discussed) and the content items about which feedback was provided must also be classifiable into a plurality of categories. For example, the content items may be classifiable into any number of categories such as “news,” “consumer products,” “automobiles,” “technology,” “luxury,” and the like. However, these are only some examples, and content items may be classified into a wide variety of other arbitrarily-defined categories.

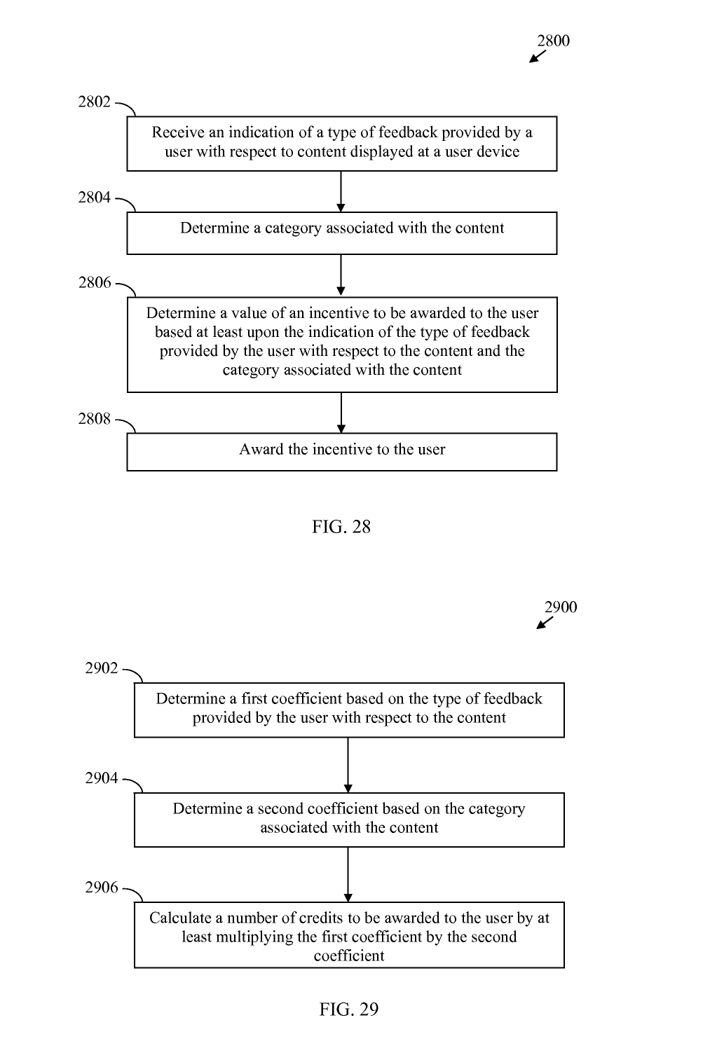

FIG. 28 depicts a flowchart 2800 of a method by which server 2504 may operate to determine a value of an incentive based upon a type of feedback provided by a user with respect to content and a category associated with the content and to award the incentive to the user. Although the method of flowchart 2800 will now be described with continued reference to components of incentive system 2500, persons skilled in the relevant art(s) will appreciate that the method may be implemented by other components or systems.

As shown in FIG. 28, the method of flowchart 2800 begins at step 2802, in which an indication of a type of feedback provided by a user with respect to content displayed at a user device is received. This step may be performed, for example, by network interface 2512 of server 2504 when network interface 2512 receives feedback measures signal 2536. As was previously described, feedback measures signal 2536 may include an indication of how many instances of each of a plurality of predefined feedback types the user has provided with respect to various items of content over a certain time period. However this is only an example, and the indication received during step 2802 may be represented in other forms. For example, the indication received during step 2802 may simply indicate that the user has provided a particular type of feedback with respect to a single item of content.

At step 2804, a category associated with the content about which feedback was provided by the user is determined. This step may be performed, for example, by evaluation engine 2540. The category associated with the content may be determined in a number of ways. For example, in one embodiment, the category or an indication thereof may be received as part of feedback measures signal 2536 (i.e., agent 2532 may include the category type or an indication thereof in the information that it reports to server 2504). In another embodiment, evaluation engine 2540 or some other component of server 2504 may identify the content about which feedback is being provided and apply a classification algorithm to it so as to determine the appropriate category. However, these examples are not intended to be limiting and still other techniques may be used to determine the category associated with the content.

At step 2806, a value of an incentive to be awarded to the user is determined based at least upon the indication of the type of feedback provided by the user with respect to the content and the category associated with the content. This step may be performed, for example, by evaluation engine 2540.

At step 2808, the incentive is awarded to the user. This step may also be performed, for example, by evaluation engine 2540. Evaluation engine 2540 may award the incentive to the user by assigning the incentive to a user account associated with the user. However, the awarding of the incentive to the user may be carried out using other techniques as well. For example, the incentive itself or information sufficient to redeem the incentive may simply be sent to the user via any one of a variety of physical or digital communication channels.

As noted above, the value of the incentive determined during step 2806 is determined based at least upon the indication of the type of feedback provided by the user with respect to the content and the category associated with the content. As was previously discussed, in an embodiment in which there are three feedback types comprising “No,” “More” and “Deep,” each feedback type may result in the assignment of a different incentive value. In the embodiment described in flowchart 2800, the incentive value is further determined based on the category about which feedback was provided, wherein different categories are associated with different award values. This approach may be used when obtaining user feedback about one category of content is more valuable to a content provider than obtaining user feedback about another category of content. For example, obtaining feedback about luxury items and automobiles may be more valuable to a content provider than obtaining feedback about entertainment or sports content, because the content provider may be able to generate more ad revenue by targeting ads to users who like luxury items and automobiles than targeting ads to users who like entertainment and sports.

In an embodiment in which the incentives comprise credits that accrue to a user account, a first multiplier or coefficient may be assigned to each feedback type (as was discussed above in reference to Table 1) and a second multiplier or coefficient may be assigned to each content category. For example, a scheme such as that shown below in Table 2 may be used to determine the coefficient for each category of content.

TABLE 2

| Category | Coefficient | Explanation |
|---|---|---|
| Luxury | 1.5x | High value for content provider |
| Autos | 1.2x | Intermediate value for content provider |
| Sports | 1x | Low value for content provider |

To determine a number of credits that should be added to the user's user account, the number of instances of a particular feedback type with respect to a particular category of content provided by a user over a certain time period can be multiplied by the coefficient for the particular feedback type and the coefficient for the particular category. Thus, for example, if a user provided 4 “No” types of feedback with respect to content items in the luxury items category during a particular time period, evaluation engine 2540 may determine that the user should be awarded (1×1.5×4)=6 credits. As another example, if a user provided 1 “Deep” type of feedback with respect to a content item in the sports category during a particular time period, evaluation engine 2540 may determine that the user should be awarded (4×1×1)=4 credits. Of course, this scheme is provided by way of example only. Persons skilled in the relevant art(s) will appreciate that any number of schemes may be developed to determine the value of an incentive based on feedback type and content category.

To further illustrate some of the foregoing concepts, FIG. 29 depicts a flowchart of a method 2900 for determining a value of an incentive to be awarded to a user based at least upon on indication of a type of feedback provided by the user with respect to content and a category associated with the content. In one embodiment, the method of flowchart 2900 is performed by evaluation engine 2540 within system 2500. However, persons skilled in the relevant art(s) will appreciate that the method may be implemented by other components or systems.

As shown in FIG. 29, the method of flowchart 2900 begins at step 2902 in which a first coefficient is determined based on the type of feedback provided by the user with respect to the content. By way of example only, the first coefficient may be determined in accordance with Table 1 above which maps each of a “No,” “More” and “Deep” feedback type to a corresponding coefficient.

At step 2904, a second coefficient is determined based on the category associated with the content. By way of example only, the second coefficient may be determined in accordance with Table 2 above which maps each of a “Luxury,” “Autos” and “Sports” content category to a corresponding coefficient.

At step 2906, a number of credits to be awarded to the user is calculated by at least multiplying the first coefficient by the second coefficient. For example, the number of credits to be awarded to the user may be calculated by multiplying the first coefficient (which corresponds to a particular feedback type) by the second coefficient (which corresponds to a particular content category) by the number of times the user provided that particular feedback type in the particular content category. Once the number of credits has been calculated, evaluation engine 2540 may add the credits to an accumulated number of credits associated with the user's user account.

Evaluation engine 2540 may take other factors into account when determining the value of incentives to be awarded to a user. For example, in one embodiment, evaluation engine 2540 may place a limit on the total number of credits that can be added to the user's user account in a given time period (e.g., hour, day, month, etc.). For example, evaluation engine 2540 may enforce a 100 credit/day limit such that a user may not add more than 100 additional credits to their account in a day.

Evaluation engine 2540 may also operate to assign an incentive step level to the user based at least on the accumulated number of credits associated with the user's user account. The incentive step level may be used to determine a rate at which credits are accumulated to the user account. For example, when a user has earned a certain number of credits, evaluation engine 2540 may promote the user from a first incentive step level to a second incentive step level, wherein membership in the second incentive step level enables the user to accumulate credits at a faster rate than the user could in the first incentive step level. Different step levels may be given different titles, such as “bronze,” “silver,” “gold” and “platinum” to help users distinguish among them.

### IV. Example Incentive System Based on User Time Span of Viewing and/or Content

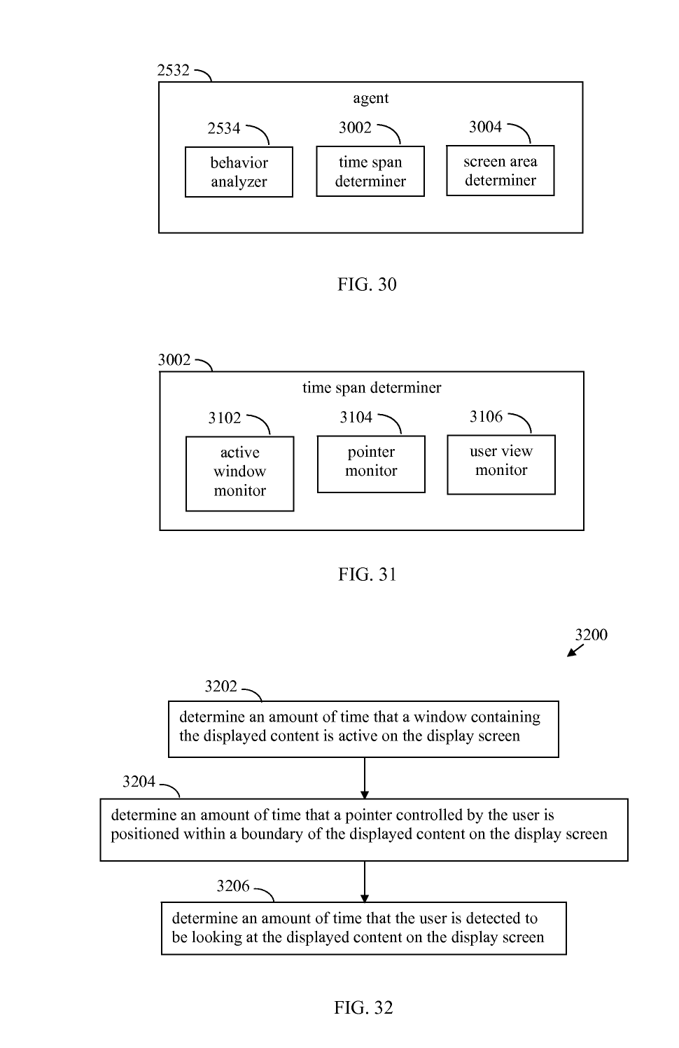

Embodiments of systems and methods that incentivize users to provide feedback about, consume, and/or interact with content based on content view times and display areas are described. Such an incentive system and/or method may be implemented in devices and servers in various ways, including being implemented in incentive system 2500 shown in FIG. 25. For instance, FIG. 30 shows a block diagram of agent 2532 of FIG. 25, according to an example embodiment. In the example of FIG. 30, agent 2532 is configured to track user interaction times with displayed content, and to track screen area sizes of content displayed to a user, according to example embodiments. The user interaction times and/or screen area sizes that are tracked for a user may be provided to a server to determine incentives to provide to the user to incentivize content interaction and consumption.

As shown in FIG. 30, agent 2532 includes behavior analyzer 2534, a time span determiner 3002, and a screen area determiner 3004. Behavior analyzer 2534 is described above. Time span determiner 3002 and screen area determiner 3004 are described as follows.

Time span determiner 3002 is configured to track an amount of time (a “time span”) that a user views content displayed a user device. The greater the amount of time that the displayed content is viewed, the greater the incentive that may be provided to the user viewing the displayed content. For instance, with reference to FIG. 25, time span determiner 3002 may track an amount of time that a user views displayed content 2526, which is displayed on display screen 2510 of user device 2502. As described above, the user may also interact with displayed content 2526 to provide feedback. The tracked amount of time may be transmitted to server 2504, where evaluation engine 2540 may determine an incentive to be awarded to the user based on the tracked amount of time (and optionally further based on any feedback provided by the user, as well as based on the area taken on display screen 2510 by the displayed content, as further described below).

Time span determiner 3002 may be configured in various ways to track user viewing time. For instance, FIG. 31 shows a block diagram of time span determiner 3002, according to an example embodiment. As shown in FIG. 31, time span determiner 3002 includes an active window monitor 3102, a pointer monitor 3104, and a user view monitor 3106. Each of active window monitor 3102, pointer monitor 3104, and user view monitor 3106 are configured to track time spans of users viewing content in a corresponding way, and one or more of active window monitor 3102, pointer monitor 3104, and user view monitor 3106 may be included in an instance of time span determiner 3002 in embodiments.

For illustrative purposes, active window monitor 3102, pointer monitor 3104, and user view monitor 3106 are described as follows with respect to FIG. 32. FIG. 32 shows a flowchart 3200 of various processes for determining a time span spent by a user viewing displayed content, according to example embodiments. In an embodiment, time span determiner 3002 may operate according to flowchart 3200. For instance, active window monitor 3102 (when present) may operate according to step 3202 of flowchart 3200, pointer monitor 3104 (when present) may operate according to step 3204 of flowchart 3200, and user view monitor 3106 (when present) may operate according to step 3206 of flowchart 3200. Flowchart 3200 and features of time span determiner 3002 are described as follows. Further structural and operational embodiments will be apparent to persons skilled in the relevant art(s) based on the following description.

Flowchart 3200 begins with step 3202. In step 3202, an amount of time is determined that a window containing the displayed content is active on the display screen. For instance, in an embodiment, active window monitor 3102 may be configured to determine a time span over which a window containing displayed content 2526 (FIG. 25) is an active window, where an “active window” is considered to be a window currently selected by a user (e.g., by a user “clicking” in the window, etc.) or otherwise selected to be the focused/foremost active window (e.g., the window of display screen 2510 where keystrokes or other user interface interactions are sent). Active window monitor 3102 may include a clock or timer, or may access a clock or timer (e.g., of an operating system), to record a start time when the window became active and an end time (also referred to as a “departure time”) when the window becomes de-active. Active window monitor 3102 may determine the time span that the window is active to be the difference in time between the start time and the end time. This time span may also be referred to as the “content active time.”

In step 3204, an amount of time is determined that a pointer controlled by the user is positioned within a boundary of the displayed content on the display screen. For instance, in an embodiment, pointer monitor 3104 may be configured to determine a time span over which displayed content 2526 (FIG. 25) contains a pointer (e.g., a mouse pointer, touch pad pointer, etc.) maneuvered by the user to be positioned within a boundary of displayed content 2526. Pointer monitor 3104 may include a clock or timer, or may access a clock or timer (e.g., of an operating system), to record a start time when the pointer is detected to have moved over displayed content 2526 and an end time when the pointer is detected to have moved off of displayed content 2526. Pointer monitor 3104 may determine the time span that the pointer is positioned within a boundary of displayed content 2526 to be the difference in time between the start time and the end time. This time span may also be referred to as the “mouse over time.”

In step 3206, an amount of time is determined that the user is detected to be looking at the displayed content on the display screen. For instance, in an embodiment, user view monitor 3106 may be configured to determine a time span over which a user views displayed content 2526 (FIG. 25) with their eyes. In an embodiment, the user device (e.g., user device 2502) may include one or more cameras that may capture an image stream (e.g., a video stream) of the eyes of the user. User view monitor 3106 may perform one or more image processing techniques or algorithms (e.g., facial recognition, object recognition, etc.) on images of the image stream to determine where on display screen 2510 the user is looking, and in particular, whether the eyes of the user are directed at the region of display screen 2510 bounded by displayed content 2526. User view monitor 3106 may include a clock or timer, or may access a clock or timer (e.g., of an operating system), to record a start time when the user's eyes become directed at displayed content 2526 and an end time when the user's eyes are no longer directed at displayed content 2526. User view monitor 3106 may determine the time span that the user is looking at displayed content 2526 to be the difference in time between the start time and the end time. This time span may also be referred to as the “eye over time.”

Depending on which of active window monitor 3102, pointer monitor 3104, and user view monitor 3106 are present, time span determiner 3002 records the corresponding time span(s) to transmit to a back-end system (e.g., evaluation engine 2540 of server 2504) together with additional information (e.g., feedback provided on the displayed content, a number of interactions with the displayed content, a screen area of the displayed content, etc.). Each time span may be optionally transmitted to the server with a time span type identifier identifying whether the time span is a “content active time”-type time span, a “mouse over time”-type time span, or an “eye over time”-type time span.

Referring back to FIG. 30, screen area determiner 3004 is configured to determine a proportion of an area of a display screen filled by the displayed content at a user device. The larger the relative area of the displayed content to the display screen area, the greater the incentive that may be provided to the user viewing the displayed content. For instance, with reference to FIG. 25, screen area determiner 3004 may determine the area of displayed content 2526 (or optionally of the window containing displayed content 2526), and may determine the area of display screen 2510, and based on the determined areas may determine the proportion of the area of display screen 2510 filled by displayed content 2526. For instance, screen area determiner 3004 may divide the area of displayed content 2526 by the area of display screen 2510 to determine the proportion (and may optionally multiply the result by 100 to obtain the proportion in the form of a percentage). The areas of displayed content 2526 and display screen 2510 may be determined and/or maintained in any form, including as numbers of pixels, as lengths and widths, in square inches, in square centimeters, etc. The determined proportion may be transmitted to server 2504, where evaluation engine 2540 may determine an incentive to be awarded to the user based on the determined proportion (and optionally further based on any feedback provided by the user, as well as based on the content viewing time span(s), as further described above).

Furthermore, whenever the size of displayed content 2526 (e.g., the size of a window containing displayed content 2526) changes due to a user's interaction to provide feedback (e.g., indicating “No,” “More,” or “Deep,” etc.) or merely to resize the window/content, a new proportion may be calculated. For each proportion that is determined, a time span may be determined for the time that the proportion was present (e.g., the time span that the window size for particular displayed content 2526 was constant).

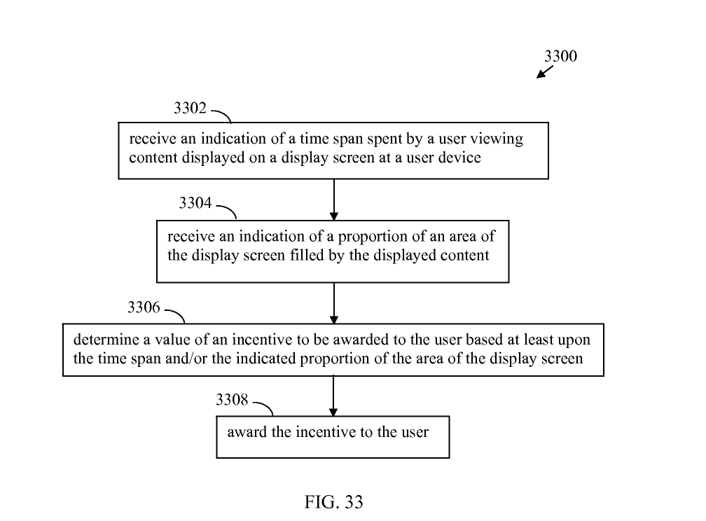

This information may be provided to a server in any manner, and may be used by the server to determine an incentive for a user in any manner. For example, FIG. 33 shows a flowchart of a process for determining and awarding an incentive to a user for an amount of time spent viewing content and/or based on an area of a display screen used by the displayed content, according to an example embodiment. In an embodiment, server 2504 of FIG. 25 may operate according to flowchart 3300. Flowchart 3300 is described as follows with respect to server 2504. Further structural and operational embodiments will be apparent to persons skilled in the relevant art(s) based on the following description.

Flowchart 3300 begins with step 3302. In step 3302, an indication is received of a time span spent by a user viewing content displayed on a display screen at a user device. For example, in an embodiment, agent 2532 transmits the time span(s) determined by time span determiner 3002 (FIGS. 30, 31), as described above, via network interface 2506 as part of a tracked information signal 2548. Server 2504 receives tracked information signal 2548 via network interface 2512.

In step 3304, an indication is received of a proportion of an area of the display screen filled by the displayed content. In an embodiment, agent 2532 transmits the proportion(s) determined by screen area determiner 3004 (FIG. 30), as described above, via network interface 2506 as part of tracked information signal 2548. Server 2504 receives tracked information signal 2548 via network interface 2512.

Note that in embodiments, step 3302 may be performed without performing step 3304 to determine incentives based on time spans but not on content/display screen proportions, or step 3304 may be performed without performing step 3302 to determine incentives based on content/display screen proportions but not on time spans, or both steps 3302 and 3304 may be performed to determine incentives based on both time spans and content/display screen proportions. In any embodiments, incentives may be determined based on time spans and/or content/display screen proportions, and optionally in combination with feedback received from the user on displayed content, and optionally on a number of feedback interactions by the user with the displayed content, as described in the prior section.

Note that in an embodiment, time span indications and content/display screen proportions may be received (e.g., in signal 2548 of FIG. 25) together in a data set. For instance, the following data set may be recorded by agent 2532 and received for a user that viewed a displayed content item for 60 seconds, at 100% proportion of the display screen, and provided one “Deep” feedback indication on the displayed content:

1 incidence of Deep

(60, 100)

Where the data pair (60, 100) indicates the 60 seconds at 100% of the display screen. Alternatively, this information may be provided in any other manner or configuration.

Referring back to FIG. 33, in step 3306, a value of an incentive to be awarded to the user is determined based at least upon the time span and/or the indicated proportion of the area of the display screen. In an embodiment, evaluation engine 2540 is configured to utilize the tracked information included in tracked information signal 2548, including the one or more time spans and/or one or more content/display screen proportions, to determine one or more incentives that will be awarded to the user as part of the incentive program. Evaluation engine 2540 then awards the incentives to the user by assigning the incentives to a user account associated with the user. This may be carried out by storing information about the incentives to be awarded to the user in association with the user account. Such information may be stored, for example, in user account data storage 2546. Any type of incentive described herein or otherwise known may be awarded to a user based on the information.

In step 3308, the incentive is awarded to the user. This step may also be performed, for example, by evaluation engine 2540 and/or redemption engine 2542. Evaluation engine 2540 may award the incentive to the user by assigning the incentive to a user account associated with the user. However, the awarding of the incentive to the user may be carried out using other techniques as well. For example, the incentive itself or information sufficient to redeem the incentive may simply be sent to the user via any one of a variety of physical or digital communication channels.

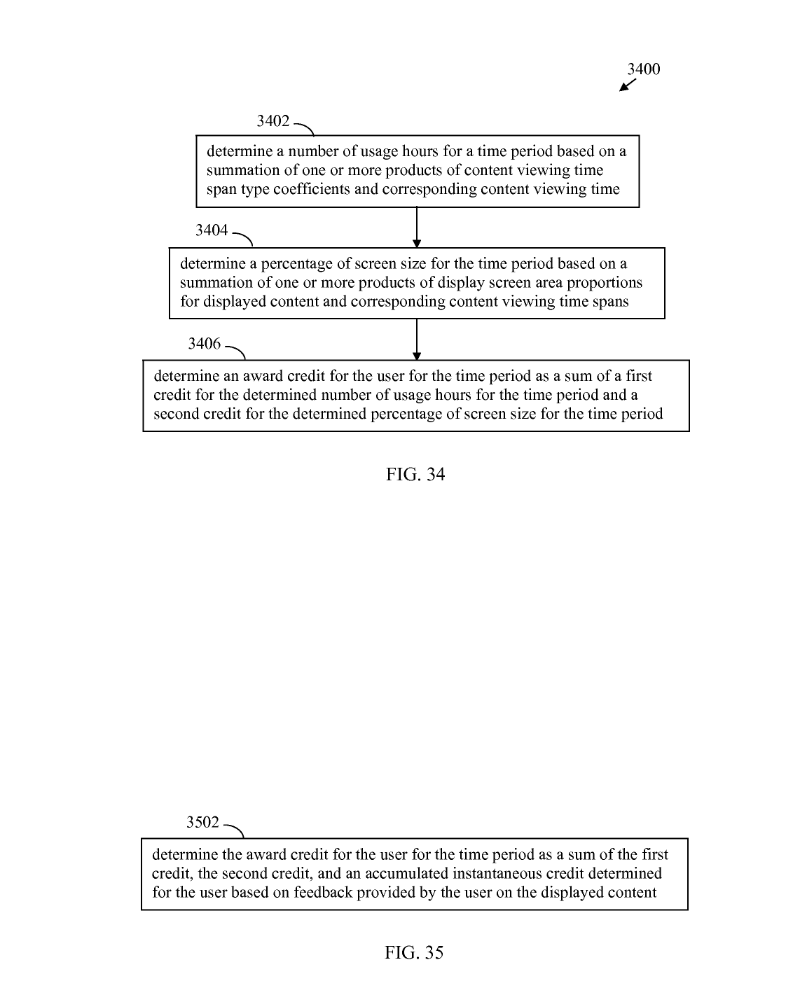

The value of an incentive to be awarded to a user based at least upon the time span and/or the indicated proportion of the area of the display screen (step 3306) may be determined in various ways. For instance, FIG. 34 shows a flowchart 3400 of a process for calculating an award credit for a user based on an amount of time the user spent viewing content on a display screen and/or based on an area of the display screen used by the displayed content, according to an example embodiment. In an embodiment, evaluation engine 2540 of FIG. 25 may operate according to flowchart 3400. Flowchart 3400 is described as follows with respect to evaluation engine 2540. Further structural and operational embodiments will be apparent to persons skilled in the relevant art(s) based on the following description.

Flowchart 3400 begins with step 3402. In step 3402, a number of usage hours for a time period is determined based on a summation of one or more products of a content viewing time span type coefficient and a corresponding content viewing time. In an embodiment, evaluation engine 2540 may be configured to determine a number of usage hours for a time period for a user. The time period may be any time period, such as an hour, a day, a week, etc. The number of usage hours may be determined based on the one or more time spans determined by time span determiner 3002 for the user. For instance, in an embodiment, evaluation engine 2540 may be configured to determine a number of usage hours for a day-long time period for a user according to the following equation:

$$\# of uage hours a day = ( {\sum }_{k = 1}^{n} coefficient of time span type * Time Span ( k ) ) + 86 , 400 \qquad Equation 1$$

where

n=the number of pairs of values of (time span in seconds, proportion of screen size) received for a particular day;

Time Span (k)=the kth time span;
coefficient of time span type=a coefficient for the type of time span of corresponding Time Span (k); and

86,400=a time factor.

In the example of Equation 1, the time factor of 86,400 is the number of seconds in a day, and thus is used to relate the result to a day. In other examples, different time factors could be used (or a time factor may not be present).

Furthermore, the presence of the coefficient of time span type is optional in Equation 1. The coefficient of time span type may be used to weight different types of time spans differently. This is because, in an embodiment, a plurality of predefined time span types may be present. The plurality of predefined time span types may include one or more of: a first time span type that indicates the time span as an amount of time that a window containing the displayed content is active on the display screen (“content active time”); a second time span type that indicates the time span as an amount of time that a pointer controlled by the user is positioned within a boundary of the displayed content on the display screen (“mouse over time”); and/or a third time span type that indicates the time span as an amount of time that the user is detected to be looking at the displayed content on the display screen (“eye over time”). Further and/or alternative types of time span types may also be present.

Referring back to FIG. 34, in step 3404, a percentage of screen size for the time period is determined based on a summation of one or more products of display screen area proportions for displayed content and corresponding content viewing time spans. In an embodiment, evaluation engine 2540 may be configured to determine a percentage of screen size for the time period for the user. As mentioned above, the time period may be any time period, such as an hour, a day, a week, etc. The percentage of screen size may be determined based on the one or more content/display screen proportions and corresponding time spans determined by screen area determiner 3004 for the user. For instance, in an embodiment, evaluation engine 2540 may be configured to determine a percentage of screen size for a day-long time period for a user according to the following equation:

$$\% of screen size a day = {\sum }_{k = 1}^{n} Time Span ( k ) / 86 , 400 \times ratio of screen size ( k ) \qquad Equation 2$$

where

n=the number of pairs of values of (time span in seconds, proportion of screen size) received for a particular day;

Time Span (k)=the kth time span;

ratio of screen size (k)=the kth content/display screen proportion;

coefficient of time span type=a coefficient for the type of time span of corresponding Time Span (k); and

86,400=a time factor.

Similarly to Equation 1 above, in the example of Equation 2, the time factor of 86,400 is the number of seconds in a day, and thus is used to relate the result to a day. In other examples, different time factors could be used (or a time factor may not be present).

Referring back to FIG. 34, in step 3406, an award credit is determined for the user for the time period as a sum of a first credit for the determined number of usage hours for the time period and a second credit for the determined percentage of screen size for the time period. In an embodiment, evaluation engine 2540 may be configured to determine an award credit for the time period for the user based on the determined number of usage hours for the time period and the determined percentage of screen size for the time period. For example, evaluation engine 2540 may sum credits proportional to the determined number of usage hours and to the percentage of screen size for the time period, or by combining such credits in another manner. For instance, in an embodiment, evaluation engine 2540 may be configured to determine the award credit for a day time period according to the following equation:

Total credit for a day=Credit for (# of usage hours a day)+Credit for (% of screen size a day) Equation 3

In other words, a first number of credits proportional to the determined number of usage hours for the time period may be summed with a second number of credits proportional to the determined percentage of screen size for the time period to determine the total award credit for the day.

For instance, as the number of usage hours in a time period increases, the first number of credits may also be increased, and as the percentage of screen size for the day increases, the second number of credits may also be increased. In both cases, the increase in the number of credits may be linear or nonlinear. Furthermore, in both cases, the number of credits may be determined by a formula or algorithm, by reference to a table, or in another manner. For example, a Table 3 is shown below providing a number of first credits for different values of the number of usage hours in a day time period:

TABLE 3

| # of usage hours a day | Credits given |
|---|---|
| Between 0 and 2 hours | 0 |
| Between 2 hours and 8 hours | 5 |
| Between 8 hours and 16 hours | 10 |
| Between 16 hours and 24 hours | 15 |

Furthermore, a Table 4 is shown below providing a number of second credits for different values of the percentage of screen size in a day time period:

TABLE 4

| % of screen size a day | Credits given |
|---|---|
| Between 0% and 10% | 0 |
| Between 10% and 30% | 4 |
| Between 30% and 60% | 8 |
| Between 60% and 100% | 16 |

In the example of Tables 3 and 4, if evaluation engine 2540 determines a user viewing displayed content had a number of 3 usage hours in a particular day (e.g., according to Equation 1), and had a percentage of screen size of 25% for that particular day (e.g., according to Equation 2), evaluation engine 2540 may determine the award credit for the user according to Equation 3 as:

$$\begin{matrix}Total credit for a day = 5 credits ( from row 2 of Table 3 ) + \\ 4 credits ( from row 2 of Table 4 ) \\ = 9 credits\end{matrix}$$

Note that as mentioned above, the accumulations of credits do not need to be calculated in a linear way. For example, a concave function for the accumulation of each of usage hours and percentage of screen size may be used, where the increment of credits allocated to one type of response decreases as the number of the same type of responses given by the user increases during one interaction session. Similarly, the credit assigned to the user for the time spent on a particular type of content can be a concave function, where the incrementing of credit decreases as the time spent increases. Still further, the credit assigned to the user based on the proportion or size of screen can be any arbitrary function. Even further, evaluation engine 2540 may place a ceiling on the number or amount of credits awarded to each of user for any given time interval.

It is noted that in embodiments, the instantaneous credits determined for a user based on user feedback, as described in the prior section, may also be factored into the credit award determined for the user. For instance, in an embodiment, evaluation engine 2540 may be configured to determine the award credit for a day time period according to the following equation:

Total credit for a day=an accumulation of instantaneous credits for the day+Credit for (# of usage hours a day)+Credit for (% of screen size a day) Equation 4

In other words, the instantaneous credits accumulated by the user during the time period (e.g., as described above with respect to FIGS. 26-29) may be summed with the first number of credits proportional to the determined number of usage hours for the time period and the second number of credits proportional to the determined percentage of screen size for the time period to determine the total award credit for the day.

For instance, continuing the above example with respect to Tables 3 and 4, if evaluation engine 2540 determines a user had earned 7 credits in the day (e.g., according to flowchart 2906), evaluation engine 2540 may determine the award credit for the user according to Equation 4 as:

$$\begin{matrix}Total credit for a day = 7 credits + 5 credits + 4 credits \\ = 16 credits\end{matrix}$$

Accordingly, step 3406 of FIG. 34 may be modified as shown in FIG. 35. FIG. 35 shows a step 3502 according to an example embodiment. In step 3502, the award credit is determined for the user for the time period as a sum of the first credit, the second credit, and an accumulated instantaneous credit determined for the user based on feedback provided by the user on the displayed content.

### V. Example User Device and Server Embodiments

Each of the components of user device 102, server 104, server 500, user device 2502, server 2504, agent 2532, time span determiner 3002, and each of the steps of the flowcharts shown in FIGS. 2, 3, 6-10, 26-29, and 32-35 may be implemented in hardware, or hardware combined with software and/or firmware. For example, one or more of the components of user device 102, server 104, server 500, user device 2502, server 2504, agent 2532, time span determiner 3002, and one or more of the steps of the flowcharts shown in FIGS. 2, 3, 6-10, 26-29, and 32-35 may be implemented as computer program code/instructions configured to be executed in one or more processors and stored in a computer readable storage medium. Furthermore, one or more of the components of user device 102, server 104, server 500, user device 2502, server 2504, agent 2532, time span determiner 3002, and one or more of the steps of the flowcharts shown in FIGS. 2, 3, 6-10, 26-29, and 32-35 may be implemented as hardware logic/electrical circuitry.

For instance, in an embodiment, one or more of the components of user device 102, server 104, server 500, user device 2502, server 2504, agent 2532, time span determiner 3002, and one or more of the steps of the flowcharts shown in FIGS. 2, 3, 6-10, 26-29, and 32-35 may be implemented in a system-on-chip (SoC). The SoC may include an integrated circuit chip that includes one or more of a processor (e.g., a central processing unit (CPU), microcontroller, microprocessor, digital signal processor (DSP), etc.), memory, one or more communication interfaces, and/or further circuits, and optionally embedded firmware to perform its functions.

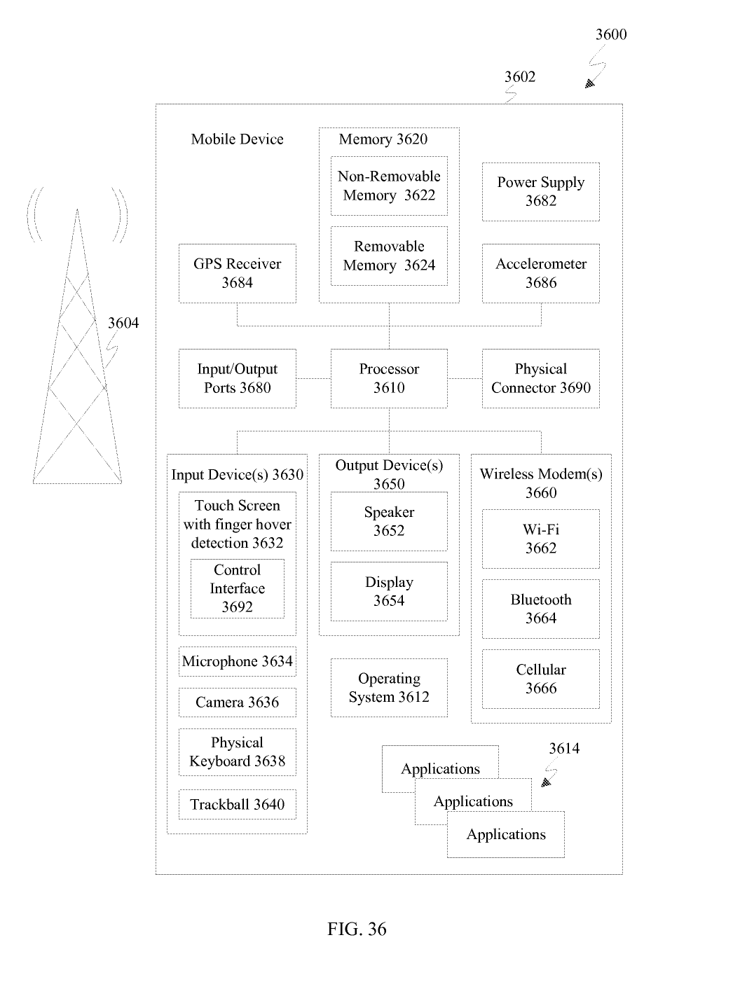

FIG. 36 shows a block diagram of an exemplary mobile device 3600 including a variety of optional hardware and software components, shown generally as components 3602. For instance, components 3602 of mobile device 3600 are examples of components that may be included in user device 102 (FIG. 1) and user device 2502 (FIG. 25) in mobile device embodiments, but are not shown in the respective figures for ease of illustration. Any number and combination of the features/elements of components 3602 may be included in a mobile device embodiment, as well as additional and/or alternative features/elements, as would be known to persons skilled in the relevant art(s). It is noted that any of components 3602 can communicate with any other of components 3602, although not all connections are shown, for ease of illustration. Mobile device 3600 can be any of a variety of mobile devices described or mentioned elsewhere herein or otherwise known (e.g., cell phone, smartphone, handheld computer, Personal Digital Assistant (PDA), etc.) and can allow wireless two-way communications with one or more mobile devices over one or more communications networks 3604, such as a cellular or satellite network, or with a local area or wide area network.

The illustrated mobile device 3600 can include a controller or processor 3610 (e.g., signal processor, microprocessor, ASIC, or other control and processing logic circuitry) for performing such tasks as signal coding, data processing, input/output processing, power control, and/or other functions. An operating system 3612 can control the allocation and usage of components 3602 and support for one or more application programs 3614 (a.k.a. applications, “apps”, etc.). Application programs 3614 can include common mobile computing applications (e.g., email applications, calendars, contact managers, web browsers, messaging applications) and any other computing applications (e.g., word processing applications, mapping applications, media player applications).

As illustrated, mobile device 3600 can include memory 3620. Memory 3620 can include non-removable memory 3622 and/or removable memory 3624. Non-removable memory 3622 can include RAM, ROM, flash memory, a hard disk, or other well-known memory storage technologies. Removable memory 3624 can include flash memory or a Subscriber Identity Module (SIM) card, which is well known in GSM communication systems, or other well-known memory storage technologies, such as “smart cards.” Memory 3620 can be used for storing data and/or code for running operating system 3612 and applications 3614. Example data can include web pages, text, images, sound files, video data, or other data sets to be sent to and/or received from one or more network servers or other devices via one or more wired or wireless networks. Memory 3620 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

A number of program modules may be stored in memory 3620. These programs include operating system 3612, one or more application programs 3614, and other program modules and program data. Examples of such application programs or program modules may include, for example, computer program logic (e.g., computer program code or instructions) for implementing one or more of the components of user device 102 or user device 2502, or one or more steps of the flowcharts of FIGS. 2, 3, and 32 and/or further embodiments described herein.

Mobile device 3600 can support one or more input devices 3630, such as a touch screen 3632, microphone 3634, camera 3636, physical keyboard 3638 and/or trackball 3640 and one or more output devices 3650, such as a speaker 3652 and a display 3654. Touch screens, such as touch screen 3632, can detect input in different ways. For example, capacitive touch screens detect touch input when an object (e.g., a fingertip) distorts or interrupts an electrical current running across the surface. As another example, touch screens can use optical sensors to detect touch input when beams from the optical sensors are interrupted. Physical contact with the surface of the screen is not necessary for input to be detected by some touch screens. For example, the touch screen 3632 may be configured to support finger hover detection using capacitive sensing, as is well understood in the art. Other detection techniques can be used, as already described above, including camera-based detection and ultrasonic-based detection. To implement a finger hover, a user's finger is typically within a predetermined spaced distance above the touch screen, such as between 0.1 to 0.25 inches, or between 0.0.25 inches and 0.05 inches, or between 0.0.5 inches and 0.75 inches or between 0.75 inches and 1 inch, or between 1 inch and 1.5 inches, etc.

Touch screen 3632 is shown to include a control interface 3692 for illustrative purposes. Control interface 3692 is configured to control content associated with a virtual element that is displayed on touch screen 3632. In an example embodiment, control interface 3692 is configured to control content that is provided by one or more of applications 3614. For instance, when a user of mobile device 3600 utilizes an application, control interface 3692 may be presented to the user on touch screen 3632 to enable the user to access controls that control such content. Presentation of control interface 3692 may be based on (e.g., triggered by) detection of a motion within a designated distance from the touch screen 3632 or absence of such motion.

Other possible output devices (not shown) can include piezoelectric or other haptic output devices. Some devices can serve more than one input/output function. For example, touch screen 3632 and display 3654 can be combined in a single input/output device. Input devices 3630 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, operating system 3612 or applications 3614 can comprise speech-recognition software as part of a voice control interface that allows a user to operate device 3600 via voice commands. Further, device 3600 can comprise input devices and software that allows for user interaction via a user's spatial gestures, such as detecting and interpreting gestures to provide input to a gaming application.

Wireless modem(s) 3660 can be coupled to antenna(s) (not shown) and can support two-way communications between processor 3610 and external devices, as is well understood in the art. Modem(s) 3660 are shown generically and can include a cellular modem 3666 for communicating with mobile communication network 3604 and/or other radio-based modems (e.g., Bluetooth 3664 and/or Wi-Fi 3662). Cellular modem 3666 may be configured to enable phone calls (and optionally transmit data) according to any suitable communication standard or technology, such as GSM, 3G, 4G, 5G, etc. At least one of wireless modem(s) 3660 is typically configured for communication with one or more cellular networks, such as a GSM network for data and voice communications within a single cellular network, between cellular networks, or between the mobile device and a public switched telephone network (PSTN).

Mobile device 3600 can further include at least one input/output port 3680, a power supply 3682, a satellite navigation system receiver 3684, such as a Global Positioning System (GPS) receiver, an accelerometer 3686, and/or a physical connector 3690, which can be a USB port, IEEE 1394 (FireWire) port, and/or RS-232 port. The illustrated components 3602 are not required or all-inclusive, as any components can be not present and other components can be additionally present as would be recognized by one skilled in the art.

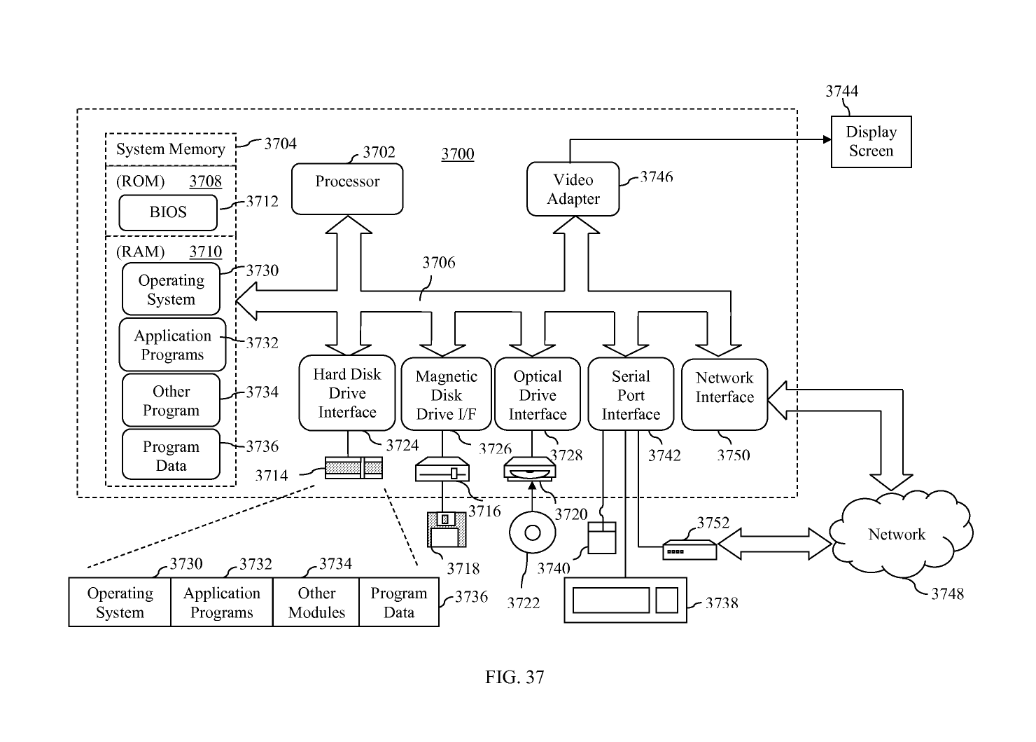

Furthermore, FIG. 37 depicts an exemplary implementation of a computing device 3700 in which embodiments may be implemented. For example, user device 102, user device 2502, server 104, server 500, or server 2504 may be implemented in one or more computing devices similar to computing device 3700 in stationary computer embodiments, including one or more features of computing device 3700 and/or alternative features. The description of computing device 3700 provided herein is provided for purposes of illustration, and is not intended to be limiting. Embodiments may be implemented in further types of computer systems, as would be known to persons skilled in the relevant art(s).

As shown in FIG. 37, computing device 3700 includes one or more processors 3702, a system memory 3704, and a bus 3706 that couples various system components including system memory 3704 to processor 3702. Bus 3706 represents one or more of any of several types of bus structures, including a memory bus or memory controller, a peripheral bus, an accelerated graphics port, and a processor or local bus using any of a variety of bus architectures. System memory 3704 includes read only memory (ROM) 3708 and random access memory (RAM) 3710. A basic input/output system 3712 (BIOS) is stored in ROM 3708.

Computing device 3700 also has one or more of the following drives: a hard disk drive 3714 for reading from and writing to a hard disk, a magnetic disk drive 3716 for reading from or writing to a removable magnetic disk 3718, and an optical disk drive 3720 for reading from or writing to a removable optical disk 3722 such as a CD ROM, DVD ROM, or other optical media. Hard disk drive 3714, magnetic disk drive 3716, and optical disk drive 3720 are connected to bus 3706 by a hard disk drive interface 3724, a magnetic disk drive interface 3726, and an optical drive interface 3728, respectively. The drives and their associated computer-readable media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, RAMs, ROMs, and the like.

A number of program modules may be stored on the hard disk, magnetic disk, optical disk, ROM, or RAM. These programs include an operating system 3730, one or more application programs 3732, other program modules 3734, and program data 3736. These programs may include, for example, computer program logic (e.g., computer program code or instructions) for implementing one or more components of user device 102, server 104, server 500, user device 2502, server 2504, agent 2532, time span determiner 3002, and one or more of the steps of the flowcharts shown in FIGS. 2, 3, 6-10, 26-29, and 32-35, and/or further embodiments described herein.

A user may enter commands and information into computing device 3700 through input devices such as a keyboard 3738 and a pointing device 3740. Other input devices (not shown) may include a microphone, joystick, game pad, satellite dish, scanner, a touch screen and/or touch pad, a voice recognition system to receive voice input, a gesture recognition system to receive gesture input, or the like. These and other input devices may be connected to processor 3702 through a serial port interface 3742 that is coupled to bus 3706, but may be connected by other interfaces, such as a parallel port, game port, or a universal serial bus (USB).

A display screen 3744 is also connected to bus 3706 via an interface, such as a video adapter 3746. Display screen 3744 may be external to, or incorporated in computing device 3700. Display screen 3744 may display information, as well as being a user interface for receiving user commands and/or other information (e.g., by touch, finger gestures, virtual keyboard, etc.). In addition to display screen 3744, computing device 3700 may include other peripheral output devices (not shown) such as speakers and printers.

Computing device 3700 is connected to a network 3748 (e.g., the Internet) through an adaptor or network interface 3750, a modem 3752, or other means for establishing communications over the network. Modem 3752, which may be internal or external, may be connected to bus 3706 via serial port interface 3742, as shown in FIG. 37, or may be connected to bus 3706 using another interface type, including a parallel interface.

As used herein, the terms “computer program medium,” “computer-readable medium,” and “computer-readable storage medium” are used to generally refer to media such as the hard disk associated with hard disk drive 3714, removable magnetic disk 3718, removable optical disk 3722, system memory 3704, flash memory cards, digital video disks, RAMs, ROMs, and further types of physical/tangible storage media. Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media.

As noted above, computer programs and modules (including application programs 3732 and other program modules 3734) may be stored on the hard disk, magnetic disk, optical disk, ROM, or RAM. Such computer programs may also be received via network interface 3750, serial port interface 3742, or any other interface type. Such computer programs, when executed or loaded by an application, enable computing device 3700 to implement features of embodiments discussed herein. Accordingly, such computer programs represent controllers of the computing device 3700.

As such, embodiments are also directed to computer program products comprising computer instructions/code stored on any computer useable storage medium. Such code/instructions, when executed in one or more data processing devices, causes a data processing device(s) to operate as described herein. Examples of computer-readable storage devices that may include computer readable storage media include storage devices such as RAM, hard drives, floppy disk drives, CD ROM drives, DVD ROM drives, zip disk drives, tape drives, magnetic storage device drives, optical storage device drives, MEMs devices, nanotechnology-based storage devices, and further types of physical/tangible computer readable storage devices.

### VI. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method, comprising:
receiving an indication of a time span spent by a user viewing content displayed on a display screen at a user device;
determining a value of an incentive to be awarded to the user based at least upon the time span; and
awarding the incentive to the user.

2. The method of claim 1, further comprising:
receiving an indication of a type of feedback provided by the user with respect to the displayed content, the type of feedback provided by the user comprising one of a plurality of predefined feedback types, the plurality of predefined feedback types including:
a first feedback type that indicates that the user does not like the content;
a second feedback type that indicates that the user likes the content and wants to see additional content that is topically related thereto; and
a third feedback type that indicates that the user likes the content and wants to see additional information about the content or conduct at least one transaction with respect to the content.

3. The method of claim 2, wherein said receiving an indication of a type of feedback provided by the user with respect to the content displayed at the user device comprises:
receiving an indication of a number of incidences of the indicated type of feedback provided by the user with respect to the displayed content.

4. The method of claim 1, wherein the time span is associated with one of a plurality of predefined time span types, the plurality of predefined time span types including at least one of:
a first time span type that indicates the time span as an amount of time that a window containing the displayed content is active on the display screen;
a second time span type that indicates the time span as an amount of time that a pointer controlled by the user is positioned within a boundary of the displayed content on the display screen; or
a third time span type that indicates the time span as an amount of time that the user is detected to be looking at the displayed content on the display screen.

5. The method of claim 1, wherein said receiving comprises:
receiving an indication of a proportion of an area of the display screen filled by the displayed content.

6. The method of claim 5, wherein said determining a value of an incentive comprises:
determining the value of the incentive to be awarded to the user based at least upon the time span spent by the user viewing the content displayed on the display screen and the proportion of an area of the display screen filled by the displayed content.

7. The method of claim 6, wherein said determining the value of the incentive to be awarded to the user based at least upon the time span spent by the user viewing the content displayed on the display screen and the proportion of an area of the display screen filled by the displayed content comprises:
determining a number of usage hours for a time period based on a summation of one or more products of a content viewing time span type coefficient and a corresponding content viewing time span;
determining a percentage of screen size for the time period based on a summation of one or more products of a display screen area proportion for displayed content and a corresponding content viewing time span; and
determining an award credit for the user for the time period as a sum of a first credit for the determined number of usage hours for the time period and a second credit for the determined percentage of screen size for the time period.

8. The method of claim 7, wherein said determining an award credit for the user for the time period comprises:
determining the award credit for the user for the time period as a sum of the first credit, the second credit, and an accumulated instantaneous credit determined for the user based on feedback provided by the user on the displayed content.

9. A system, comprising:
a network interface operable to receive an indication of a time span spent by a user viewing content displayed on a display screen at a user device;
an evaluation engine operable to determine a value of an incentive to be awarded to the user based at least upon the time span and to award the incentive to the user.

10. The system of claim 9, wherein the network interface is further operable to receive an indication of a type of feedback provided by the user with respect to the displayed content, the type of feedback provided by the user comprising one of a plurality of predefined feedback types, the plurality of predefined feedback types including:
a first feedback type that indicates that the user does not like the content;
a second feedback type that indicates that the user likes the content and wants to see additional content that is topically related thereto; and
a third feedback type that indicates that the user likes the content and wants to see additional information about the content or conduct at least one transaction with respect to the content.

11. The system of claim 10, wherein the network interface is further operable to receive an indication of a number of incidences of the indicated type of feedback provided by the user with respect to the displayed content.

12. The system of claim 9, wherein the time span is associated with one of a plurality of predefined time span types, the plurality of predefined time span types including at least one of:
a first time span type that indicates the time span as an amount of time that a window containing the displayed content is active on the display screen;
a second time span type that indicates the time span as an amount of time that a pointer controlled by the user is positioned within a boundary of the displayed content on the display screen; or
a third time span type that indicates the time span as an amount of time that the user is detected to be looking at the displayed content on the display screen.

13. The system of claim 9, wherein the network interface is further operable to receive an indication of a proportion of an area of the display screen filled by the displayed content.

14. The system of claim 13, wherein the evaluation engine is configured to determine the value of the incentive to be awarded to the user based at least upon the time span spent by the user viewing the content displayed on the display screen and the proportion of an area of the display screen filled by the displayed content.

15. The system of claim 14, wherein, to determine the value of the incentive to be awarded to the user, the evaluation engine is configured to:
determine a number of usage hours for a time period based on a summation of one or more products of a content viewing time span type coefficient and a corresponding content viewing time span;
determine a percentage of screen size for the time period based on a summation of one or more products of a display screen area proportion for displayed content and a corresponding content viewing time span; and
determine an award credit for the user for the time period as a sum of a first credit for the determined number of usage hours for the time period and a second credit for the determined percentage of screen size for the time period.

16. The system of claim 15, wherein the evaluation engine is configured to determine the award credit for the user for the time period as a sum of the first credit, the second credit, and an accumulated instantaneous credit determined for the user based on feedback provided by the user on the displayed content.

17. The system of claim 16, further comprising:
a redemption engine operable to provide an interface by which the user can redeem the award credit.

18. A computer-readable storage medium comprising computer-executable instructions that, when executed by a processor, perform a method comprising:
receiving an indication of a time span spent by a user viewing content displayed on a display screen at a user device;
receiving an indication of a proportion of an area of the display screen filled by the displayed content;
determining a value of an incentive to be awarded to the user based at least upon the time span and the indicated proportion of the area of the display screen; and
awarding the incentive to the user.

19. The computer-readable storage medium of claim 18, wherein the time span is associated with one of a plurality of predefined time span types, the plurality of predefined time span types including at least one of:
a first time span type that indicates the time span as an amount of time that a window containing the displayed content is active on the display screen;
a second time span type that indicates the time span as an amount of time that a pointer controlled by the user is positioned within a boundary of the displayed content on the display screen; or
a third time span type that indicates the time span as an amount of time that the user is detected to be looking at the displayed content on the display screen.

20. The computer-readable storage medium of claim 18, wherein said determining the value of the incentive to be awarded to the user comprises:
determining a number of usage hours for a time period based on a summation of one or more products of a content viewing time span type coefficient and a corresponding content viewing time span;
determining a percentage of screen size for the time period based on a summation of one or more products of a display screen area proportion for displayed content and a corresponding content viewing time span; and
determining an award credit for the user for the time period as a sum of at least a first credit for the determined number of usage hours for the time period and a second credit for the determined percentage of screen size for the time period.
